(19) United States
(12) Patent Application Publication
(10) Pub. No.: US 2008/0120144 A1
(43) Pub. Date: May 22, 2008

(54) Futures Based Exchange Systems And Methods

(76) Inventors: Martin James Bartell, Gidea Park (GB); Lorimer Patrick Tucker, Albury (GB)

Correspondence Address: PATENT GROUP 2N;JONES DAY, NORTH POINT, 901 LAKESIDE AVENUE, CLEVELAND, OH, 44114, US

(21) Appl. No.: 11/760,304

(22) Filed: Jun. 8, 2007

Related U.S. Application Data
(60) Provisional application No. 60/812,023, filed on Jun. 8, 2006.
(60) Provisional application No. 60/892,140, filed on Feb. 28, 2007.
(60) Provisional application No. 60/892,334, filed on Mar. 1, 2007.

(51) Int. Cl. G06Q 40/00

(52) U.S. Cl. 705/4; 705/39

(57) ABSTRACT

Systems and methods for trading property loss or damage on a futures-based exchange. A system can include receiving information related to one or more futures-based contracts. A transaction is generated with respect to the one or more futures-based contracts. The futures-based exchange is used as a clearing house with respect to the generated transaction.

### CROSS-REFERENCE TO RELATED APPLICATIONS

This application claims priority to and the benefit of U.S. Provisional Application Ser. No. 60/812,023, (entitled “Systems And Methods For Trading Reinsurance Catastrophe Business” and filed on Jun. 8, 2006), U.S. Provisional Application Ser. No. 60/892,140 (entitled “Futures Based Exchange Systems and Methods” and filed on Feb. 28, 2007), and U.S. Provisional Application Ser. No. 60/892,334 (entitled “Futures Based Exchange Systems and Methods” and filed on Mar. 1, 2007), of which the entire disclosures (including any and all figures) of all of these applications are incorporated herein by reference.

### TECHNICAL FIELD

This document relates generally to trading systems and methods and more particularly to futures, options, etc. based exchanges.

### BACKGROUND

Losses to the reinsurance market are very unpredictable as to both timing and quantum of the events. A key driver of the bigger catastrophe numbers are hurricanes/earthquakes. The US hurricane season runs from June through to November, therefore the third and fourth quarters should provide the more volatile periods of loss activity. Earthquakes can occur at any time, and therefore are not subject to the same seasonality as wind events. As a guide the highest recorded first quarter is 1994 which includes an earthquake with its epicenter in California which recorded a loss of USD 12.50 bn part of the total first quarter number of USD 14.48 bn. Therefore as precise as modeled outputs have become and the predictions of various meteorological institutes, long range weather prediction is not quite a science and is still very much at the whim of nature.

While new Bermuda based reinsurance companies have been formed post Katrina, it is estimated that these entities will only bring around USD 3.0 bn of new peak zone reinsurance catastrophe capacity to the marketplace. The new capacity will not be sufficient to satisfy the industries needs, and it is very difficult to see how the traditional reinsurance market will be able to provide the capacity required. As show in FIG. 1 at 30, there was only around in January 2005 USD 40.0 bn of reinsurance catastrophe capacity for any one peak zone. This helps illustrate that there may be a significant shortfall of funds in the future for the reinsurance/retro market.

### SUMMARY

In accordance with the teachings provided herein, systems and methods are provided for trading property loss or damage on a futures-based exchange. As an example, a method and system can include receiving information related to one or more futures-based contracts. A transaction is generated with respect to the one or more futures-based contracts. The futures-based exchange is used as a clearing house with respect to the generated transaction.

As another example, a computer-implemented system and method are disclosed for trading reinsurance risk on a futures-based or options exchange. A server is configured to receive information related to one or more futures-based or options reinsurance catastrophe contracts. A database stores the received information related to the one or more future-based or options reinsurance catastrophe contracts. The server generates a transaction with respect to the one or more futures-based or options reinsurance catastrophe contracts based upon the information received about the one or more futures-based or options reinsurance catastrophe contract. In this example, the server is a futures-based exchange server and operates as a clearing house with respect to the generated transaction. A futures based annual index of all losses above a pre-specified amount as reported by Property Claims Services (PCS) in a given period is used as an index for the exchange.

### BRIEF DESCRIPTION OF THE DRAWINGS

FIG. 1 is a block diagram depicting a significant shortfall of funds in the future for the reinsurance/retro market.

FIG. 2 is a block diagram depicting an environment wherein users can interact with a futures based exchange system.

FIG. 3 is a block diagram depicting that trading, distribution and listing of futures and/or options contracts are provided by an exchange.

FIG. 4 is a block diagram depicting that the exchange can be a clearinghouse for buyers and sellers.

FIG. 5 is a block diagram depicting that the exchange can handle many different types of derivative contracts.

FIG. 6 is a block diagram depicting that an exchange can be implemented on an electronic networked platform.

FIG. 7 is a flow chart depicting an operational scenario involving the exchange.

FIG. 8 is a block diagram depicting creation of an index.

FIG. 9 is a block diagram depicting that the exchange can display prices on user interfaces.

FIGS. 10-13 are block diagrams depicting a comparative pricing portal for use by buyers and sellers.

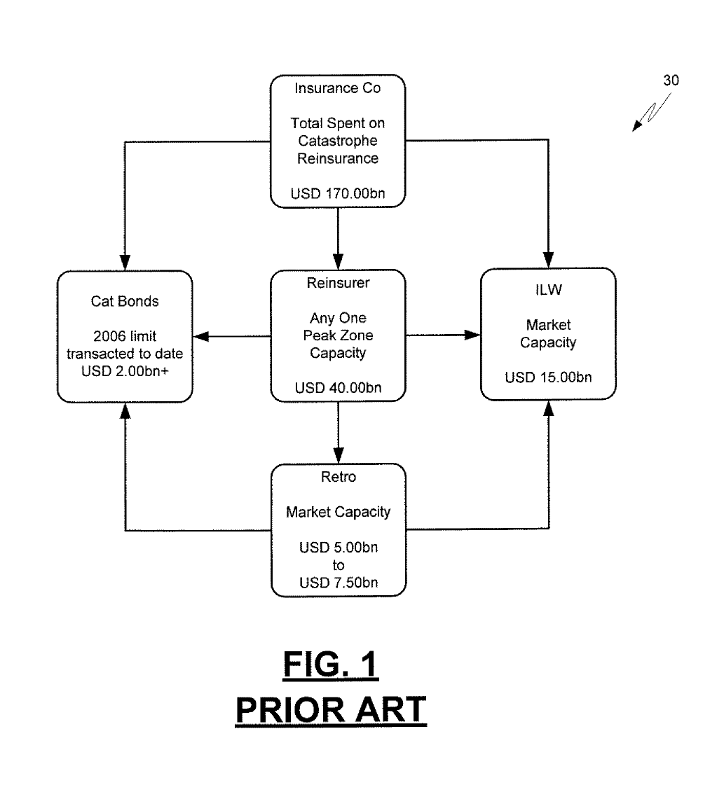

### DETAILED DESCRIPTION

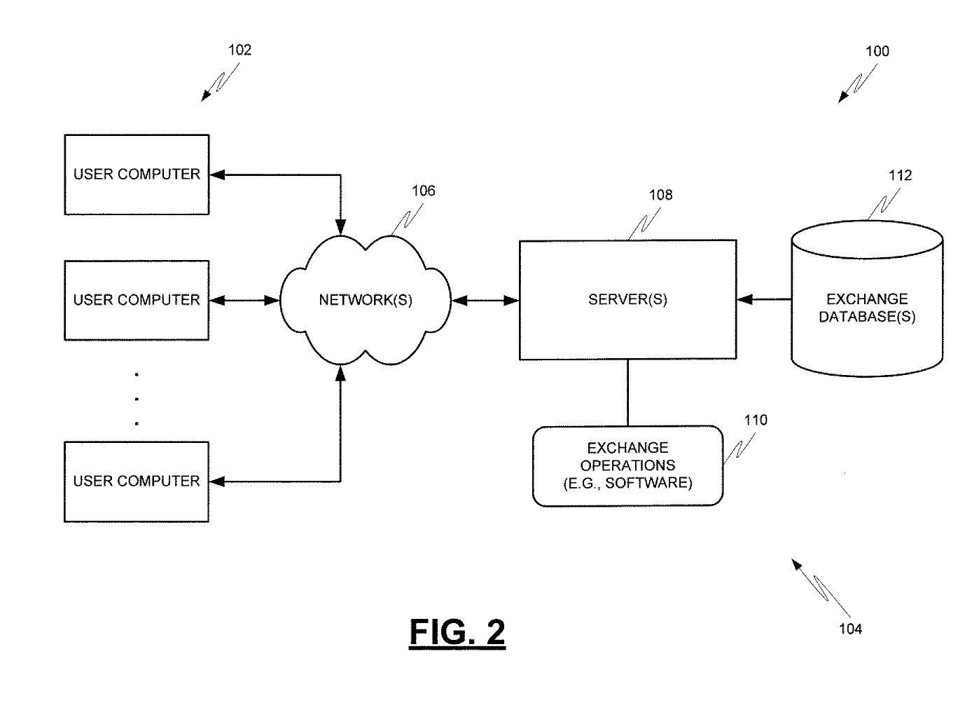

FIG. 2 depicts at 100 a computer-networked environment wherein users 102 can interact with a futures based exchange system 104 for trading in futures and/or options, such as trading in the area of the provision of property catastrophe protection (e.g., reinsurance catastrophe business). A system 104 could be configured such that real time electronic trading of reinsurance risk can take place in order to more effectively handle resource allocation when a hurricane, tornado, explosion, earthquake or other disaster involving multiple insureds and/or locations occurs.

A number of products covering a variety of insurance and/or reinsurance product lines can be available through the exchange system 104 (which could have an impact on the reinsurance marketplace). It is understood within the reinsurance marketplace that reinsurance is described as the practice whereby one party, the reinsurer, in consideration of premium paid, agrees to indemnify another party, the reinsured, for part or all of the liability assumed by the reinsured under a policy (or policies) of insurance. An example of reinsurance is an Excess of Loss (XOL) form of reinsurance under which recoveries are available when a given loss exceeds the cedant's retention defined in the agreement. Other non-limiting examples include: a pro rata form of reinsurance wherein premiums and losses are shared proportionally between cedant and reinsurer; and a stop loss form of reinsurance under which the reinsurer pays some or all of a cedant's aggregate retained losses in excess of a predetermined dollar amount or in excess of a percentage of premium.

The users 102 can interact with the futures based exchange system 104 through a number of ways, such over one or more networks 106. Server(s) 108 accessible through the network(s) 106 can host the futures based exchange system 104. The futures based exchange system 104 can be an integrated web-based trading, reporting and analysis software tool 110 that provides users flexibility and functionality for performing futures trading. Data store(s) (e.g., databases 112) can also be used to store transaction data related to the trading.

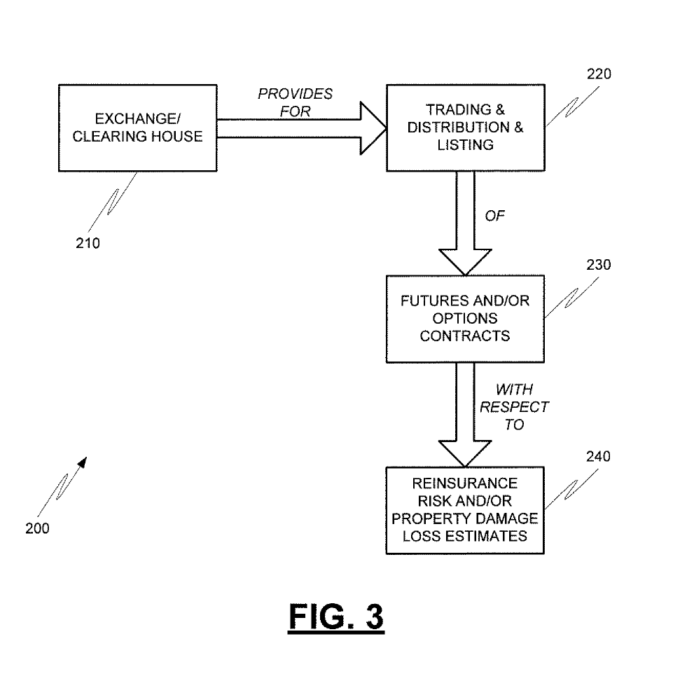

FIG. 3 depicts at 200 that trading, distribution and listing (220) of futures and/or options contracts 230 are provided by an exchange 210 which operates as the clearinghouse for transactions. The transactions involve futures and/or options contracts 230 with respect to reinsurance risk and/or property damage loss estimates 240.

The ability to trade futures based contracts 230 through the exchange 210 provides positive funding to buyers before they actually pay their clients' claims or in advance of regulatory funding requirements. This would be a benefit for an industry which, following large catastrophic claims, has significant negative cash flow issues. Likewise for sellers, a margin based cover would reduce the need for a substantial capital base to cope with infrequent large losses, or in the case of hedge funds, having to collateralize the capacity they write in advance.

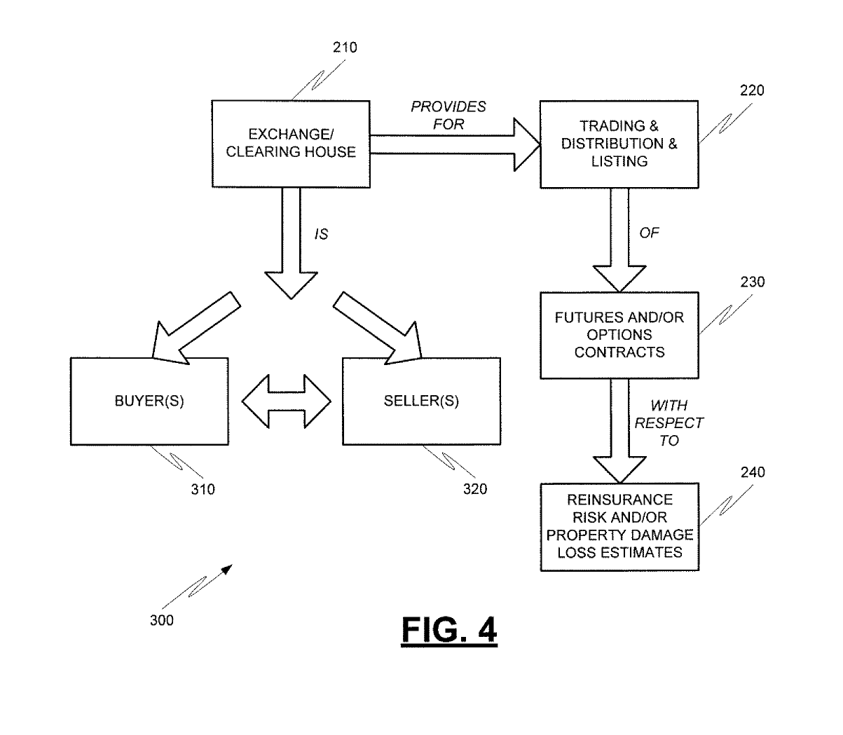

FIG. 4 depicts at 300 that the exchange 210 is the clearinghouse for buyers 310 and sellers 320 of these types of contracts 230. As a clearing house, the exchange 210 provides clearing and settlement services for the futures exchange, and acts as a central counterparty.

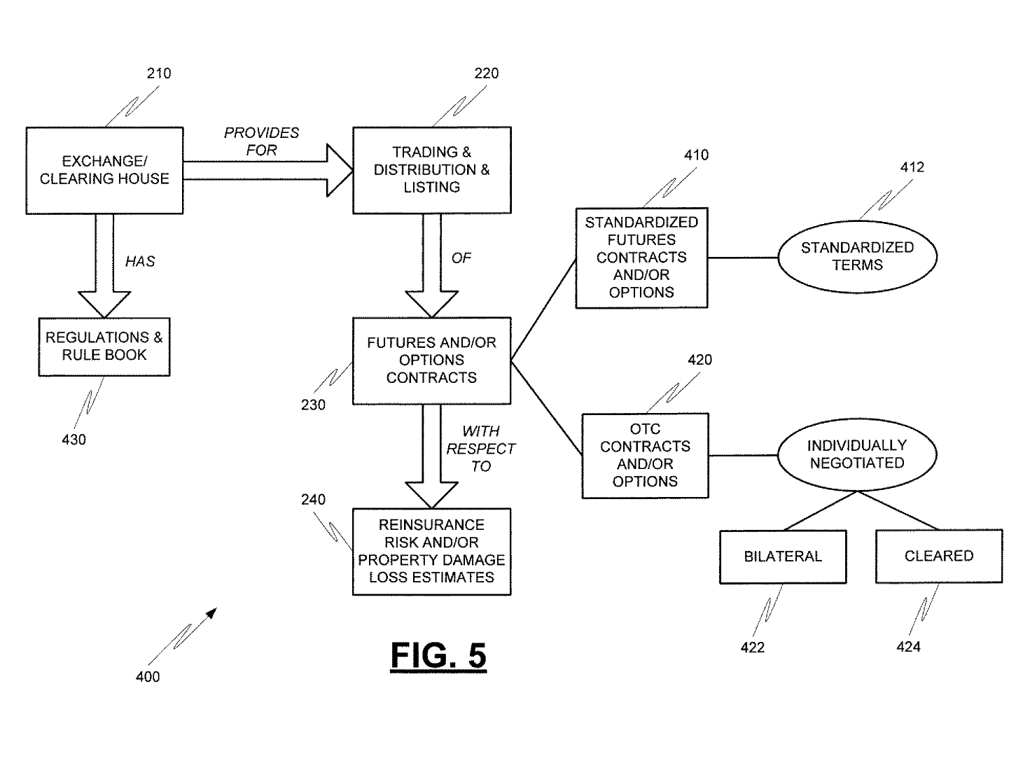

FIG. 5 depicts at 400 that the exchange 210 can handle many different types of derivative contracts, such as standardized futures contracts any and/or options 410 as well as individually negotiated OTC contracts and/or options 420 (e.g., bilateral 422 or cleared contracts 424). Based upon pre-specified regulations 430, the exchange 210 processes a transaction at 620 and acts as a clearinghouse at 630 for the transaction.

Standardized contracts 410 contain standardized terms 412. These may include pre-set settlement methods, amounts, grades and delivery and trade dates—i.e., there is nothing to negotiate. Participants establish a margin account to start trading. Credit risk is relatively low as the exchange/clearing house is a counterparty to a trade and requires margin from both sides of the trade to cover the credit risk. The market is transparent and the contracts are very liquid.

OTC contracts 420 are contracts that are traded directly between two parties. The OTC derivative is created by a dealer and tailored to suit the needs of the counterparty. Each party takes the credit risk of the other party. Accordingly OTC derivatives have customized terms, typically, using documentation forms and definitions published by the International Swaps and Derivatives Association (ISDA) as a basis.

The exchange mechanism can be configured with respect to one or more of the following: US/PCS annual market; Standard US Industry Loss Warranty (ILW) markets; US named storm ‘LiveCat’; and warrants.

US/PCS Annual Market

A futures based annual index of all ‘Cat’ losses above $25,000,000 (as reported by Property Claims Services (PCS) in a given period) can be used by the exchange platforms. PCS are recognized as the accepted industry arbiter as to the quantum of US catastrophe losses.

The insurance/reinsurance companies have significant ‘long’ positions in natural catastrophe exposures and through the exchange facility they could hedge their positions. Conversely the hedge funds have a great appetite for risk with volatility, in the traditional reinsurance market they collaterise their positions with cash for 100.0% of their liabilities. Through this facility they could only have to satisfy their margin requirement with either NYMEX (if a clearing member) or with the respective clearing member as appropriate and could have the ability to trade their position on a minute by minute basis should they desire.

The market index could be for all losses above $25,000,000 reported by PCS, for catastrophe events in the United States, in a given period, say a calendar year. Over the years 2000 to 2006 the annual loss figures reported by PCS are as follows:

| | |
|---|---|
| * 2006 | USD 2.50bn (as at 1st May 2006) |
| * 2005 | USD 56.77bn |
| * 2004 | USD 27.46bn |
| * 2003 | USD 12.88bn |
| * 2002 | USD 5.85bn |
| * 2001 | USD 26.54bn |
| * 2000 | USD 4.57bn |

Note the wide range of results this index can produce; this volatility would also apply to the quarterly numbers.

The exchange could provide the capital markets with the highly volatile market they crave and the reinsurance market with an industry aggregate stop loss which is a product that all reinsurance entities would like to buy but is not available in the traditional reinsurance/retro market place (wherein retro is a transaction whereby a reinsurer reinsures all or part of the reinsurance it has previously assumed).

Standard US Industry Loss Warranty (ILW) Markets

The industry loss warranty (ILW) market is a relatively straightforward reinsurance product to price and sell. A feel for the pricing of the product and the sustainability of that pricing is useful. ILWs are an effective way of selling aggregate in specific territories and/or for named perils around the world. They are the most commoditized product in the reinsurance market, and an area where hedge funds have been particularly active due the premium charged compared to technical price.

If an industry event reaches the predetermined threshold, as reported by PCS, the indemnity of the policy pays in full.

US Named Storm ‘LiveCat’

Although the US annual index can used in an exchange facility, it could also have the ‘LiveCat’ market up and running for 2006 wind season. The demand for this market in 2006 has the potential to be enormous due most buyers being unable to purchase the amount of protection they would have liked to buy from the traditional market.

There can be a demand for markets on each individually named hurricane basis and should there be the situation of a category five hurricane bearing down on a city, there would undoubtedly be an enormous amount of panic buying, the volatility in this scenario would very dramatic.

As with the US/PCS annual market, trading could be conducted on a margin type basis. Trading could begin in January as all hurricanes are named several years in advance, the 2006 storm names are as follows: Alberto; Beryl; Chris; Debby; Ernesto; Florence; Gordon; Helene; Isaac; Joyce; Kirk; Leslie; Michael; Nadine; Oscar; Patty; Rafael; Sandy; Tony; Valerie; and William.

The principle of the class five hurricane heading for a city could apply to any of the above named storms and as these storms form and gather strength in the Atlantic there would be approximately two weeks between formation of the hurricane and either making landfall or dissipating into the North Atlantic. If the storm did make landfall we could expect trading to continued at a frenzied pace, we could also see a grey period of trading, as it takes PCS several weeks to produce a loss number and this figure is usually finalized several months later. To provide certainty to the contract the loss figure advised by PCS as at January 2007 could be used as the final loss number for the 2006 hurricane family.

Additional contracts for use on an exchange could include:
US ‘SuperCat’ market (only events greater than USD 5.0 bn per PCS would qualify) severity hedge
US ‘MiniCat’ market (only losses less than USD 5.0 bn per PCS to qualify)=frequency hedge
European catastrophe annual market,
Individual risk annual market hedge against ‘non cat’ losses
Japan catastrophe annual market,
Aviation hull annual market,
Energy catastrophe annual market,
Life market

### In time, these markets would be traded in a similar fashion to US/PCS annual market,

Warrants

Another feature of the contracts could be to construct warrants that would apply either to individual contracts or alternatively a basket of contracts. These could be offered as a separate tradable commodity from the insurance/reinsurance contracts and could provide an enhancement for the counterparties.

The exchange's contract can become the reinsurance market standard, with the contracts embracing the ISDA form, which is universally accepted within the wider financial markets. Example contracts are provided herein. These may also contain warrants to the contracts which will also be tradable.

In handling these type of margin-based futures product contracts, the exchange would not be as capital intensive, (compared to the 100.0% cash collateral basis) until such time as the market became live—e.g., when a storm is forming in the Atlantic, a margin call could be made by the exchange or clearing house to cover the relevant parties open positions, this move in the market would also create significant trading opportunities for both futures and ‘LiveCat’ contracts.

The exchange can be welcomed by the traditional reinsurance markets and the capital markets in order to create additional capacity. For the capital markets this would allow the trading of an asset class with little or no correlation to other positions.

It is noted that reinsurance has become an attractive asset class to the hedge fund community. Their main area of activity has been the ILW market. They have typically looked to offer single shot 100.0% collaterised (with cash) deals, they perceive this form of cover best suits their modus operandi. A futures based contract approach can be used by both the hedge fund and broader capital market community for providing capital to the reinsurance industry. An exchange platform can be a way for these entities to either hedge their positions to major catastrophes or assume their exposures directly through the exchange.

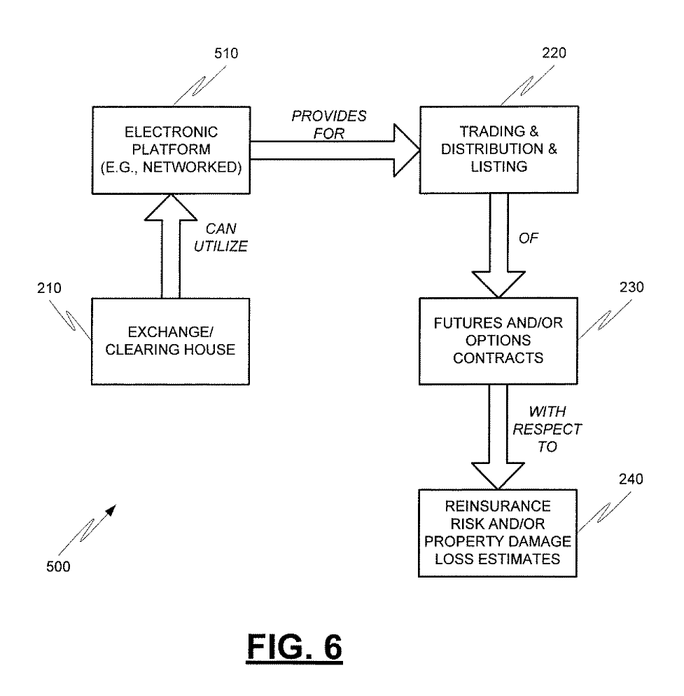

With respect to the platform, FIG. 6 depicts at 500 that an exchange 210 can be implemented on an electronic networked platform 510. The networked platform 510 can include a wide variety of communication mechanisms for buyers, sellers and other users to access the exchange 210. As an illustration, the networked platform 510 can include one or more of the following networks: wide area networks (WAN), local area networks (LAN), the Internet, intranets, a wireless networks, and combinations thereof.

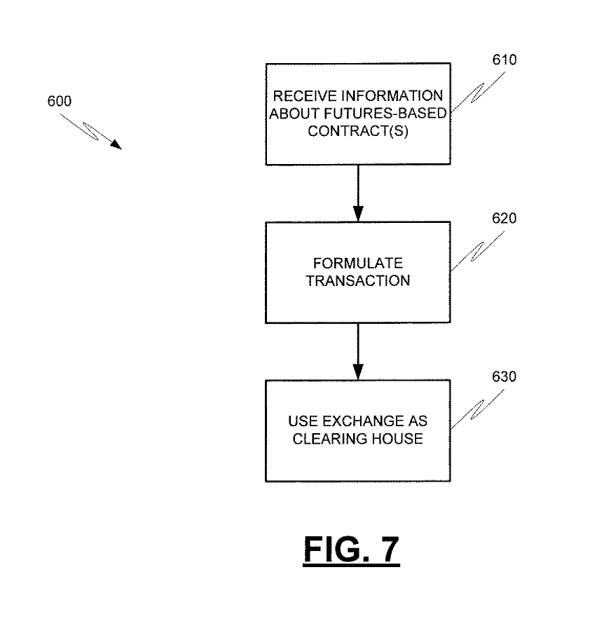

FIG. 7 depicts at 600 an operational scenario involving the exchange. The exchange receives at 610 information from a buyer or seller about a futures-based contract or contracts. Based upon the pre-specified regulations, the exchange processes the transaction at 620 and acts as a clearinghouse at 630 for the transaction.

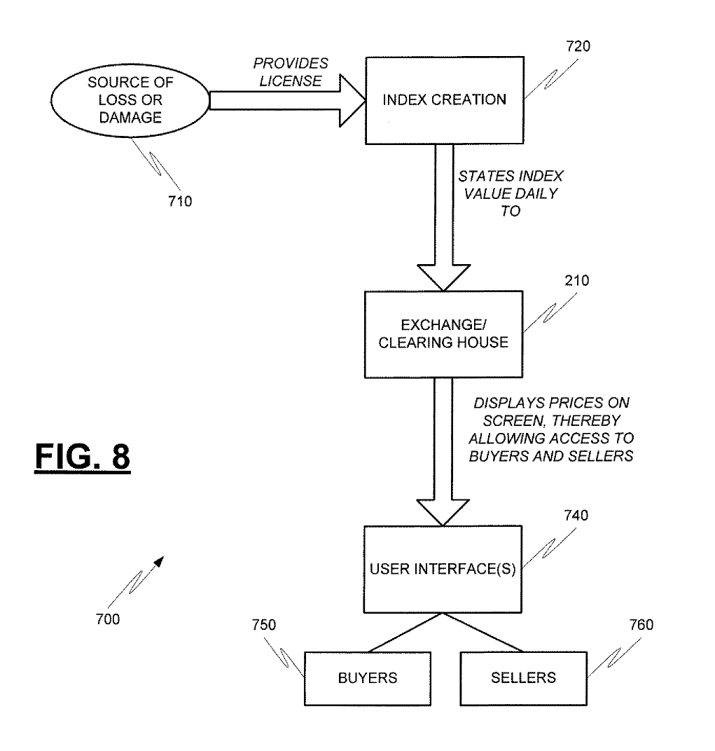

For handling the contracts, FIG. 8 depicts at 700 that an index can be created at 720 wherein the source of loss or damage 710 provides the mechanism or license for an index creator. For example, the index can be created by the following approach. In Property Claims Service (PCS), a division of the Insurance Standards Office, there is an independent assessor of the results of a natural catastrophe loss. Thus, instead of requiring an assessment of different exposures before a loss, an index can be created by the market counterparties themselves with reference to the estimated insured damage caused by a particular loss and the effect that this will have on the annual total.

The PCS methodology is well known and accepted. Indeed it has been used as the trigger for 95% of ILW contracts without any major disputes.

PCS normally report their loss estimate within 6 to 8 weeks of a major catastrophic event, in the case of hurricane Katrina due the somewhat unique nature of that event the time to report took slightly longer. However the PCS loss figure is reported much quicker than a loss effecting a traditional UNL protection. In fact PCS often report a draft number within a few days.

In addition, with the exchange offering a futures based contract the sophisticated weather monitoring and landfall predictions by various respected bodies (Risk Management Solutions/AIR and EQE); it is likely that the underlying index would move, perhaps significantly so prior to the actual loss making landfall and importantly, this could allow buyers of the index to crystallize profitable positions. Effectively market sentiment will move pricing the quickest as in most ‘real time’ trading environments. For the first time, true dynamic reinsurance pricing can take place.

Should the holder of the positions decide to take the subsequent embedded profit within the futures contracts they hold, then the exchange would provide a method of providing pre-finding for the losses they will ultimately suffer.

With a traditional reinsurance contract an insurer or reinsurer must ‘prove their loss’ to the satisfaction of their reinsurer/retrocessionaire who then settles the valid claim. Not only are disputes common in the reinsurance industry, but so are the delays in settlement. Adverse cash flows suffered by insurers can become major problems when losses are large or where organizations (e.g. Lloyd's) are subject to regulatory funding requirements on outstanding losses. Rating agencies constantly comment on the reinsurance receivables (particularly ‘aged’ balances).

The exchange mechanism would allow a pre-funding of the claims that the insurer would eventually settle. This would differentiate the exchange and its contracts from other reinsurance contracts, except Cat Bonds. In the case of Cat Bonds, the associated costs would have to reflect both the physical provision of funds and also the higher frictional costs (which would still be present even if a ‘Shelf Offering’).

In addition the modeling companies have become a part of catastrophe reinsurance placements. Even though their loss estimates have been found wanting with the latest round of losses, their view is still respected. In fact some are now undertaking loss estimates that are being used as the trigger for Cat Bonds.

It is entirely feasible that one or more of the modeling companies would be able to substantiate or substitute PCS figures if required.

As mentioned above, the exchange could use ISO's Property Claim Services (PCS) as the index arbiter. PCS is the internationally recognized independent authority on insured property losses from catastrophes in the United States, Puerto Rico, and the U.S. Virgin Islands. ISO's PCS's staff assigns Catastrophe Serial Numbers to events: that cause USD 25.0 m or more in total insured property losses, and affect a significant number of property and casualty insurance policyholders and property and casualty insurers. There are three types of catastrophe bulletins: Bulletins, Extensions, and Estimates. Bulletins are the first notice from PCS that a Catastrophe Serial Number has been assigned to an event. Extensions are updates to the Bulletins, providing additional information relating to the initial Bulletin. Estimates are reports prepared by staff stating preliminary, resurvey, or final estimates of property damage on a state basis. Information includes breakdowns for each state on the number of claims, average payment and total dollars for Personal, Commercial and Automobile losses When a disaster strikes anywhere in the United States, Puerto Rico, or the U.S. Virgin Islands, PCS investigates to determine whether the damage will meet the definition of a catastrophe. PCS now defines catastrophes as events that cause USD 25.0 m or more in direct insured losses to property and that affect a significant number of policyholders and insurers.

To gather the information needed for its services, PCS has developed a national network of insurer claim departments, insurance adjusters, emergency managers, insurance agents, meteorologists, and fire and police officials. PCS also maintains contact with industry representatives in many countries.

PCS generally combines two methods to develop the best estimate in the shortest possible time. First, PCS conducts confidential surveys of insurers, agents, adjusters, public officials, and others to gather data on claim volumes and amounts. PCS analyzes the data and combines it with trend factors to determine a loss estimate.

PCS also maintains a proprietary database containing information on the number and types of structures, by ZIP code, for every state in the country. Using that information, PCS can accurately determine the number of insurable risks in a specific geographic area. Combined with on the ground survey information, the structure data forms the basis for highly reliable damage estimates.

Just days after an event, PCS completes its first survey and releases a preliminary estimate of losses. That early information has repeatedly proven reliable. For large or unusual events, PCS resurveys the affected insurers to assure accuracy and to identify loss components and relevant claim issues. PCS continues the process until staff is confident of a fully developed estimate.

PCS is the only insurance-industry resource for compiling and reporting estimates of insured property losses resulting from catastrophes. Their reporting methodology has not resulted in any major disputes.

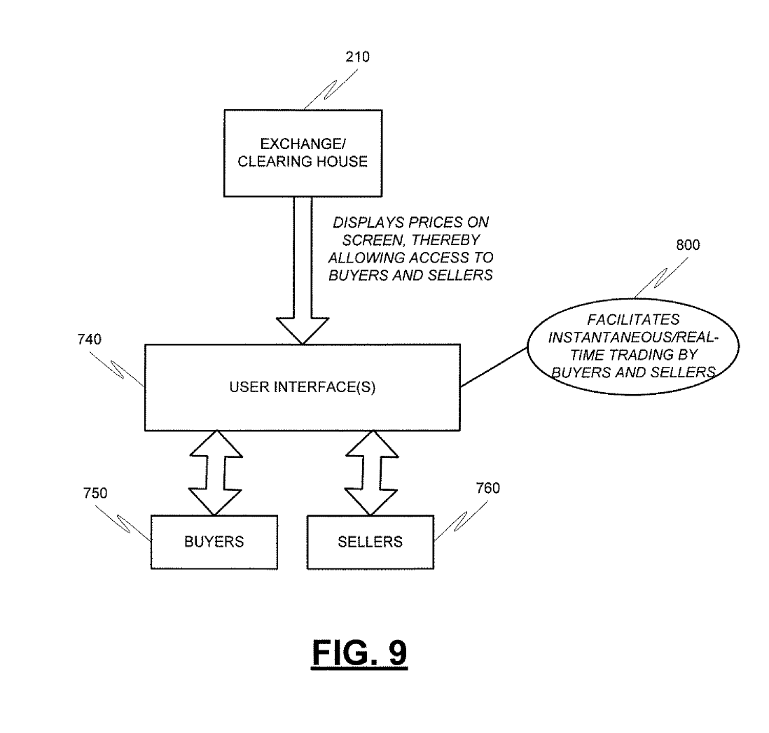

FIG. 8 further depicts that the exchange 210 can display prices on the screens of user interfaces 740, thereby allowing access to buyers 750 and sellers 760. Through the exchange screens 740, both buyers 750 and sellers 760 would be able to see exactly what capacity is available and at what price, without being reliant upon a broker. A platform can be configured to be accessed by existing trading screens or, for those without such access, via a web based interface. As illustrated at 800 in FIG. 9, the counterparties would be able to transact business virtually instantaneously. In addition the warrants that could apply to contracts will provide an additional new asset class. This platform will allow the broader capital markets access to the reinsurance market in the most capital and time efficient manner.

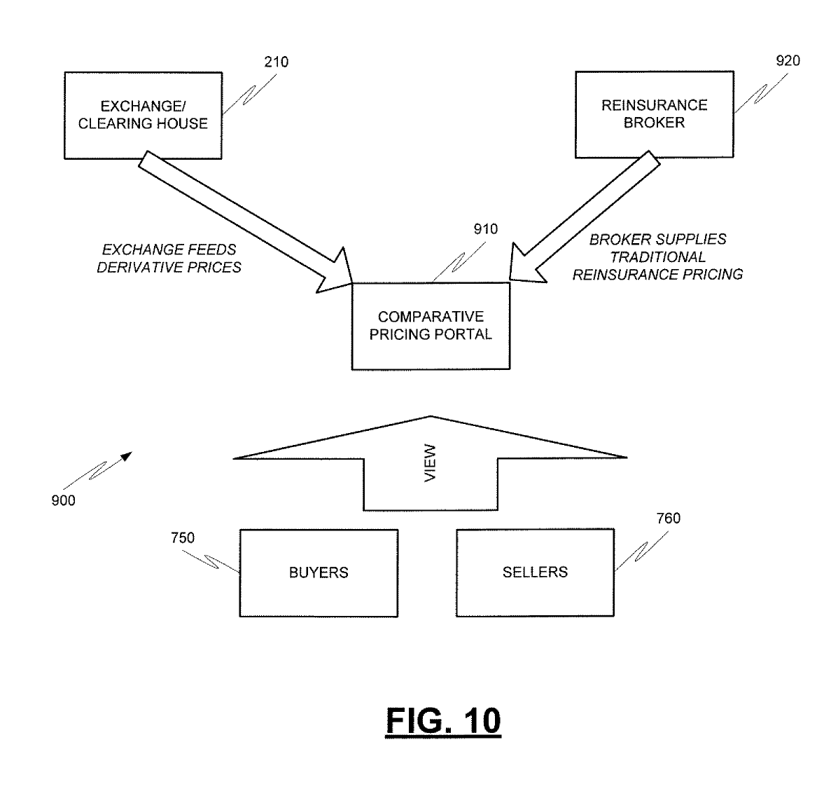

FIG. 10 depicts at 900 a comparative pricing portal 910 for viewing by buyers 750 and sellers 760. A comparative pricing portal 910 allows an exchange 210 to feed derivative prices as well as allowing a reinsurance broker 920 to supply traditional reinsurance pricing. By comparing the prices provided by the exchange 210 in the reinsurance broker 920, the buyers 750 and sellers 760 can make better informed decisions about what contracts should be bought and sold.

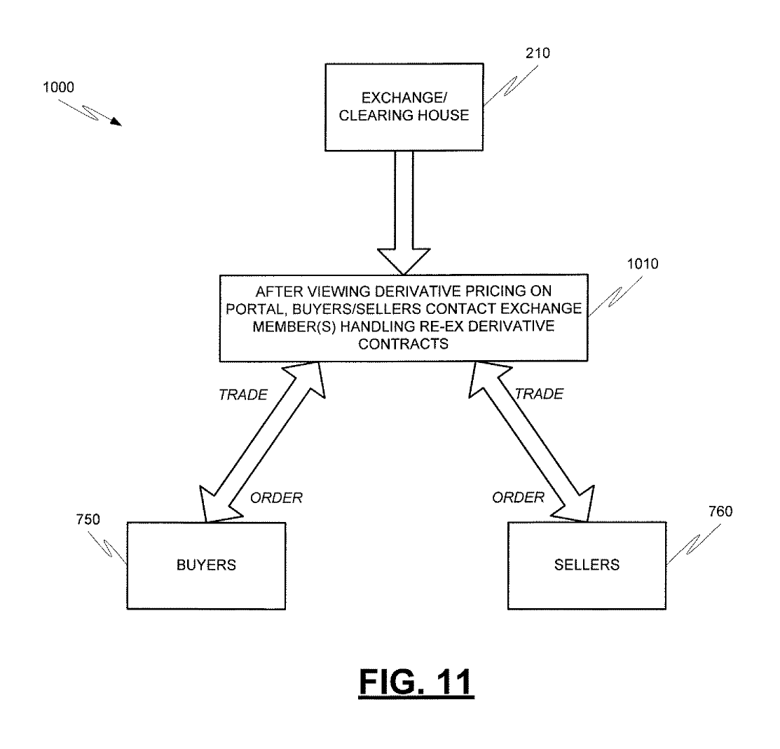

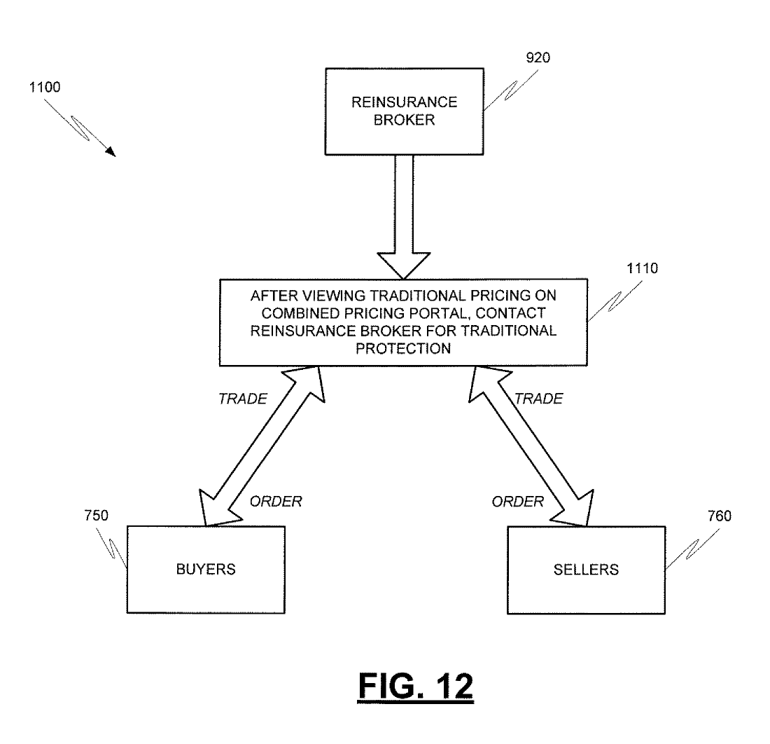

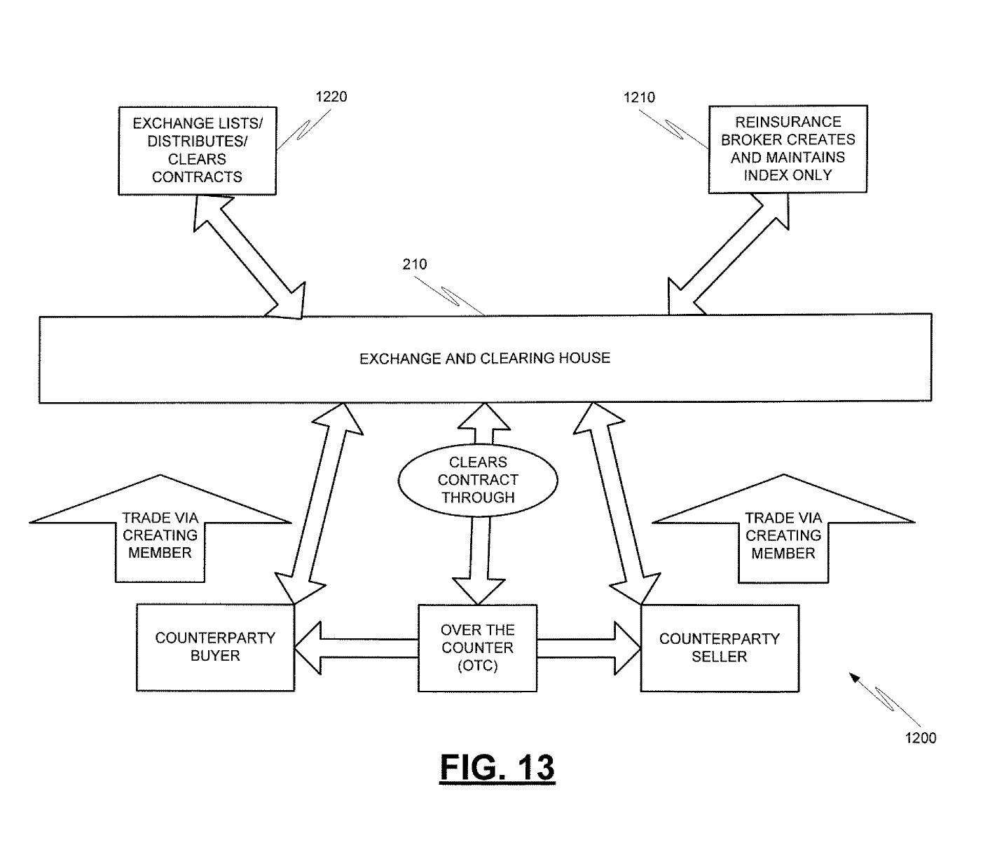

FIG. 11 illustrates at 1000 that after viewing at 1010 derivative pricing on the portal, buyers/sellers (750, 760) can contact exchange member(s) that are handling derivative contracts in order to perform trading and ordering operations. FIG. 12 illustrates at 1100 that after viewing at 1110 traditional pricing on the portal, buyers/sellers (750, 760) can contact the reinsurance broker 920 for traditional protection. FIG. 13 illustrates at 1200 that that different ways can be used to handle the contracts, such as handling OTC contracts between the counterparties. In this scenario, the reinsurance broker creates and maintains at 1210 the index only; and the exchange at 1220 lists, distributes, and clears the contracts.

While examples have been used to disclose the invention, including the best mode, and also to enable any person skilled in the art to make and use the invention, the patentable scope of the invention is defined by claims, and may include other examples that occur to those skilled in the art. Accordingly the examples disclosed herein are to be considered non-limiting. As an illustration, it should be understood that with respect to the processing flows described herein, the steps and the order of the steps in these processing flows may be altered, modified, removed and/or augmented and still achieve the desired outcome.

As another illustration, a reinsurance futures exchange can be done in response to many different types of issues, such as one or more of the following issues affecting the reinsurance industry:
The requirement for catastrophe protection is at an all time high due to a combination of recent losses, rating agency pressure and solvency requirements
Traditional providers of reinsurance can no longer supply the capacity required
Scientific evidence points to the likelihood for more frequent and severe weather systems to impact the US potentially for the next 20 years, driven by the multi-decadal North Atlantic Oscillation
In addition, the impact of global warming is causing a long term underlying trend of increased frequency and severity of hurricanes and typhoons worldwide
The traditional method of supplying fresh capital for new catastrophe writers may no longer be the most efficient method, due to the increase in capital required and the lack of an easy exit route
The exchange would open up a new asset class to the broader financial markets in a capital efficient way
This asset class is only weakly correlated, if at all, with investments currently available to financial markets and the additional diversity it would bring to an investment portfolio would make it an attractive opportunity
The exchange would provide transparency as to the capacity available and at what price
The exchange would provide a cost effective distribution on a principal to principal basis
As a cleared contract, it would be particularly attractive to buyers from credit rating viewpoint
The exchange would utilize existing, well established and known platforms, via existing trading screens or a simple web based access
The exchange would allow reinsurance risk to become a liquid product and for the first time a reinsurance contract could be traded many times over

With the traditional reinsurance/retro market struggling to cope with the demand that is being heaped on it, the exchange can result in bringing many more players, in terms of type and number, to the marketplace, trading in a way that could transform an industry that has remained wary of change.

As an illustration, the following types of buyers within the marketplace can use the exchange: petrochemical companies (e.g., BP, Exxon, Texaco, etc.); telecommunication companies (e.g., Sprint, AT&T, Bell South, etc.); utilities companies (e.g., Florida Power and Light, Tampa Electric, etc.); supermarket chains (e.g., Wal-Mart, Winn Dixie, etc.); fast food chains (e.g., McDonalds, Burger King, etc.); leisure parks (e.g., Disney, Anheuser Busch, etc.); insurance companies (e.g., Allstate, State Farm, St Paul Travellers, AIG, etc.); reinsurance companies; and retro markets. The following types of sellers within the marketplace can use the exchange: traditional reinsurance markets; traditional retro markets; hedge funds; proprietary trading desks; and soft commodity traders.

With respect to the contracts that are processed by the exchange, it should be noted that there can be one or more differences between a derivatives-based contract and an insurance contract. For example, insurance can involve individually (face-to-face) negotiations; a derivatives-based approach can be configured to be screen-based trading. Insurance can involve transactions being time consuming, such as taking weeks; a derivatives-based approach can involve near real-time or real-time electronic trading. Insurance is a contract of indemnity (e.g., provide compensation for loss, damage or death) wherein you have to prove your loss (and quantum); a derivatives-based approach can be configured to be a contract for difference wherein there is no need to prove loss just that a trigger has been reached. Insurance can involve a promise to pay or full collateral; a derivatives-based approach can be configured to be margin-based. Insurance can lack transparency; a derivatives-based approach can be configured to be market-based with transparency. Insurance can involve a trigger that is based upon a single loss event; a derivatives-based approach can be configured to be based upon all losses in one period (e.g., year/quarter). Insurance can involve individual/bespoke contracts; a derivatives-based approach can be configured to be an ISDA based standard contract. Insurance can involve post funding of losses suffered; a derivatives-based approach can be configured to involve pre-finding of losses. Insurance can involve each transaction standing on its own; a derivatives-based approach can be configured to be centrally cleared through an exchange (e.g., via NYMEX, etc.). Insurance can involve centralized processing, but with no guarantees from a processor of contracts; a derivatives-based approach can be configured to have an exchange act as a clearer guaranteeing a clearing member.

It is further noted that the systems and methods of the exchange may be implemented on various types of computer architectures, such as for example on a single general purpose computer or workstation, or on a networked system, or in a client-server configuration, or in an application service provider configuration.

It is further noted that the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein. Other implementations may also be used, however, such as firmware or even appropriately designed hardware configured to carry out the methods and systems described herein.

The systems' and methods' data (e.g., associations, mappings, etc.) may be stored and implemented in one or more different types of computer-implemented ways, such as different types of storage devices and programming constructs (e.g., data stores, RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

Still further to show the wide variations of the systems and methods disclosed herein, the following provides a series of examples of contracts that can be used with the systems and methods disclosed herein.

### Annual Catastrophe Contract Example

### Annual Catastrophe Contract

### Territorial Scope

Losses occurring in the United States of America, being the 50 States of the Union, the District of Columbia, Puerto Rico and US Virgin Islands, including its territories and possessions.

### Nature of Loss

All losses during the Contract Period, to which ISO allocate a PCS catastrophe number.

### Trading Unit

US$1,000 per Billion US$ of Loss

### Price Quotation

US$ and Cents per Billion US$ of Loss

### Trading Hours

### Contract Period

1st June 2006 (00.00.01) to 31 May 2007 (23.59.59) 2006 Local Standard Time

### Minimum Price Fluctuation

$0.01 (1 cent) per Billion Loss ($10.00 per contract)

### Last Trading Day

Trading terminates at the close of business 180 working days after the last calendar day of the contract period.

### Settlement Type

Cash

### Settlement Calculation

The figures issued by the Property Claims Service (PCS), for each catastrophe assigned a catastrophe number by PCS, for losses arising within the Territorial Scope, for the period of the contract.

The final figure to apply will be last published loss figures 180 days after the end of the active period.

### Publication

ISO's (www.iso.com) Property Claims Services (PCS), will be determine the final make up of loss to the contract.

### Fallback Settlement

If the Property Claims Service is discontinued or materially changes its methodology in a way that it makes it unsuitable for the purpose intended. The Exchange will calculate the settlement. The settlement shall be calculated by using the following formula.

The loss figure will be calculated by applying an inflated average (Per the Consumer Price Index) of all losses of USD 3,000,0000,0000 under at the date of the events, for the preceding three years.

In addition any event that RMS, EQE, AIR (or so named) announce a post loss footprint and the last loss estimate, the mid point average for any event shall apply and that average will be considered for the purpose of this contract.

All other terms as per ISDA

### Industry Loss Warranty

### All Natural Perils

### Catastrophe Example

### Territorial Scope

Losses occurring in the United States of America, being the 50 State of the Union and the District of Columbia, including its territories and possessions.

### Nature of Loss

All losses arising from any Natural Peril events and losses arising from fire following one of the following events and/or Volcanic Disturbance/Eruption, Hurricane, Wind, Tropical Storm, Rainstorm, Thunderstorm, Storm, Tempest Cyclone, Typhoon, Tornado, Tidal Wave, Tsunami, Flood, Hail, Winter Weather/Storm/Freeze, Ice Storm, Weight of Snow, Avalanche, Meteor/Asteroid Impact, Landslip, Mudslip, Subsidence, Bush Fire, Forest Fire, Wild Land Fire, Lightning including fire and any other ensuing loss following any of the above perils.

### Contract Deductible/Settlement Trigger

All losses attributable to a single Catastrophe and allocated a ISO/PCS catastrophe number that equals or exceeds USD 30,000,000,000

### Trading Unit

US$1,000

### Price Quotation

US$ and Cents per Trading Unit

### Contract Period

12 months at a date agreed between the parties

### Trading Hours

### Minimum Price Fluctuation

$0.01 (1 cent) Trading Unit, $10 per contract

### Last Trading Day

Trading terminates at the close of business 30 working days after the last calendar day of the trading period.

### Settlement Type

Cash

### Settlement Calculation

The figures issued by the Property Claims Service (PCS), for each catastrophe with a number assigned by the PCS, for losses arising within the Territorial Scope,

The final figure to apply will be last published loss figures 92 days after the end of the active period.

### Publication

Property Claims Services (PCS), figure will determine the loss figure.

### Fallback Settlement

If the Property Claims Service is discontinued or materially changes its methodology in a way that it makes it unsuitable for the purpose intended. The Exchange will calculate the settlement. The settlement shall be calculated by using the following formula.

The loss figure will be calculated by applying an inflated average (Per the Consumer Price Index) of all losses of USD 3,000,0000,0000 under at the date of the events, for the preceding three years.

In addition any event that WMS, EQE, AIR (or so named) announce a post loss footprint and the last loss estimate, the mid point average for any event shall apply and that average will be considered for the purpose of this contract.

### Individual Catastrophe Contract (LiveCat) Example

### Territorial Scope

Losses occurring in the United States of America, being the 50 States of the Union, the District of Columbia, Puerto Rico and US Virgin Islands, including its territories and possessions.

### Nature of Loss

All losses emanating from a single storm system allocated a name by the National Oceanographic and Atmospheric Administration (National Hurricane Centre—NOAA) e.g., Hurricane XXXXXX per the NOAA named hurricane list for the year in question

### Trading Unit

US$1,000

### Price Quotation

US$ and Cents per Trading Unit

### Trading Hours

To be determined

### Minimum Price Fluctuation

$0.01 (1 cent) per trading unit ($10 per contract)

### Contracts Period

Until such time as the Hurricane is downgraded by NOAA to Tropical Depression classification

### Last Trading Day

Trading terminates at the close of business 180 working days after the end of the contract period

### Settlement Type

Cash

### Settlement Calculation

The figures issued by the Property Claims Service (PCS), for the relevant storm The final figure to apply will be last published loss figures 180 days after the end of the trading period.

### Publication

ISO's (www.iso.com) Property Claims Services (PCS), will be determine the final make up of loss to the contract.

### Fallback Settlement

If the Property Claims Service is discontinued or materially changes its methodology in a way that it makes it unsuitable for the purpose intended. The Exchange will calculate the settlement. The settlement shall be calculated by using the following formula.

The loss figure will be calculated by applying an inflated average (Per the Consumer Price Index) of all losses of USD 3,000,0000,0000 under at the date of the events, for the preceding tree years. In addition any event that RMS, EQE, AIR (or so named) announce a post loss footprint and the last loss estimate, the mid point average for any event shall apply and that average will be considered for the purpose of this contract.

All other terms as per ISDA

### Master

### ‘Re-EX Contracts’

### Quarterly Options

### Texas to Maine

### 2006 Example

1. Territorial Scope

Losses Occurring in the states of Texas, Mississippi, Louisiana, Alabama, Florida, Georgia, South Carolina, North Carolina, Virginia, Washington D.C., Maryland, Delaware, New Jersey, Pennsylvania, New York, Connecticut, Rhode Island, Massachusetts, New Hampshire, Vermont, Maine and Puerto Rico and the US Virgin Islands.

2. Perils Covered

All losses defined as the sum of all losses with a Catastrophe number by Property Claims Service (PCS) which are as a result of either: Volcanic Disturbance/Eruption, Hurricane, Wind, Tropical Storm, Rainstorm, Thunderstorm, Storm, Tempest, Cyclone, Typhoon, Tornado, Tidal Wave, Tsunami, Flood, Hail, Winter Weather/Storm/Freeze, Ice Storm, Weight of Snow, Avalanche, Meteor/Asteroid Impact, Landslip, Mudslip, Subsidence, Bush Fire, Forest Fire, Wildland Fire, Lightning including fire and any other ensuing loss following any of the above perils.

3. Scope

The provision of these rules shall apply to all contracts bought or sold on the Exchange for cash settlement based on the cumulative loss estimates for the period of the contract.

4. Floating Price

The floating price to each contract is equal to the sum of the loss estimates for the contract period. Loss Estimates will be provided to NYMEX by Re-EX who will utilize the loss estimate amounts as provided by Property Claims Service (PCS). No changes will be made to the loss estimates by Re-EX who will provide individual and cumulative loss estimates.

5. Strike Intervals

The strike intervals to each contract shall be $2.00 to the Floating Price.

6. Contract Quantity and Value

The contract quantity shall be USD 1,000. Each contract shall be valued as the contract quantity multiplied by the settlement price

7. Contract Months

Trading shall be conducted in contracts for the calendar year 2006 in respect of all Losses as defined in Perils Covered above occurring during the period 1 Jan. 2006 to 31 Mar. 2006 both days inclusive, Local Standard Time, at the place where the loss occurs.

8. Prices and Fluctuation.

Prices shall be quoted in US dollars per USD 10,000,000 of losses during the contract period. The minimum price fluctuation shall be $0.01 per $10,000,000 of losses. There shall be no maximum price fluctuation

9. Termination of Trading

Trading shall cease 17.45 EST 30 Sep. 2007, in respect of losses occurring during the period 1 Jan. 2006 to 31 Mar. 2006 both days inclusive, Local Standard Time, at the place where the loss occurs.

10. Final Settlement

Delivery under the contract shall be by cash settlement. The final settlement price will be the cumulative losses for the contract period as at 12.00 pm EST 2 Oct. 2007.

11. Deductions/Commissions

For cleared contracts $2.00 per side, for OTC contracts $2.50 per side.

12. Trading Hours

Sunday to Friday hr18.00 to hr 17.45 EST

13. Loss in Progress

If this contract should expire whilst a loss is in progress, it is agreed that subject to the other conditions of this contract, all loss figures shall fall to the first date of the loss as provided by Re-EX, which shall be the first date of loss as stated by PCS.

14. Publication

The loss estimates shall be provided to NYMEX by ‘Re-EX’ who will use the ISO's (www.iso.com) Property Claims Services (PCS) figures, which will determine the final make up of loss to the contract.

15. Fallback Settlement

If the Property Claims Service is discontinued or materially changes its methodology in a way that it makes it unsuitable for the purpose intended, then NYMEX will calculate the settlement.

The settlement shall be calculated at NYMEX's sole discretion and may use the following formula.

Any event that RMS, EQE, AIR (or so named) announce (publicly or to their Licensed clients only) a loss estimate will be used as the loss for the index calculation for the contracts. The loss estimates used will be the most recent announced by (MS, EQE, AIR (or so named) on or prior to the close of the contract. In the event that more than one of or RMS, EQE, AIR (or so named) announce a loss estimate, the loss used for calculation of the index will be a simple average of the estimate for each of RMS, EQE, AIR (or so named) who publish. In the event that one or more of RMS, EQE, AIR (or so named) publish a range rather than a single point estimate, the mid point of the range will be taken as the loss estimate, from that source, as at the final settlement date.

All other terms and conditions as per ISDA agreement

### Master

### ‘Re-EX Contracts’

### Annual Binary Contract

### Texas to Maine USD 30,000,000,000

### 2006 Example

### 1. Contract Period

1 Jan. 2006 to 31 Dec. 2006 both days inclusive Local Standard Time at the place where the loss occurs.

### 2. Territorial Scope

Losses Occurring in the states of Texas, Mississippi, Louisiana, Alabama, Florida, Georgia, South Carolina, North Carolina, Virginia, Washington D.C., Maryland, Delaware, New Jersey, Pennsylvania, New York, Connecticut, Rhode Island, Massachusetts, New Hampshire, Vermont, Maine and Puerto Rico and the US Virgin Islands.

### 3. Perils Covered

All losses resulting from a Catastrophe given a single Catastrophe number by Property Claims Service (PCS) which are as a result of either: Volcanic Disturbance/Eruption, Hurricane, Wind, Tropical Storm, Rainstorm, Thunderstorm, Storm, Tempest, Cyclone, Typhoon, Tornado, Tidal Wave, Tsunami, Flood, Hail, Winter Weather/Storm/Freeze, Ice Storm, Weight of Snow, Avalanche, Meteor/Asteroid Impact, Landslip, Mudslip, Subsidence, Bush Fire, Forest Fire, Wild Land Fire, Lightning including fire and any other ensuing loss following any of the above perils.

### 4. Contract Trigger

It is a condition that this contract shall only trigger in the event of there being losses from a loss given a single Catastrophe number by PCS covered by this Agreement, occurring during the period of this contract, equal to, or greater than USD 30,000,000,000.

In the event of there being a loss, all markets shall accept the figures issued by the Property Claims Service.

### 5. Contract Value

USD1,000

### 6. Price Quotation

USD for a USD 1,000 contract

### 7. Trading Hours

Sunday to Friday hr 18.00 to hr 17.45 EST

### 8. Termination of Trading

Trading cease 1745 EST 30 June 2007 in respect of losses occurring during the period 1 Jan. 2006 to 31 Dec. 2006 both days inclusive Local Standard Time at the place where the loss occurs.

### 9. Final Settlement

Delivery under the contract shall be by cash settlement at 12.00 pm EST 2 Jul. 2007. The contracts shall expire 30 Jun. 2007 and the loss figure published by Property Claims Service on the close of business on that day shall determine whether the contract is triggered.

### 10. Settlement Type

Cash

### 11. Settlement Calculation

The figures issued by the Property Claims Service (PCS), for a single Catastrophe assigned a Catastrophe number by PCS, for losses arising within the Territorial Scope, for the period of the contract. The final figure to apply will be last published loss figures at close of business EST 30 Jun. 2007.

### 12. Publication

The loss estimates shall be provided to NYMEX by ‘Re-Ex’ who will use ISO's (www.iso.com) Property Claims Services (PCS) figures, which will determine the final make up of loss to the contract.

13. Fallback Settlement

If the Property Claims Service is discontinued or materially changes its methodology in a way that it makes it unsuitable for the purpose intended, then NYMEX will calculate the settlement. The settlement shall be calculated at NYMEX's sole discretion and may use the following formula.

Any event that RMS, EQE, AIR (or so named) announce (publicly or to their Licensed clients only) a loss estimate will be used as the loss for the index calculation for the contracts. The loss estimates used will be the most recent announced by RMS, EQE, AIR (or so named) on or prior to the close of the contract. In the event that more than one of or RMS, EQE, AIR (or so named) announce a loss estimate, the loss used for calculation of the index will be a simple average of the estimate for each of RMS, EQE, AIR (or so named) who publish. In the event that one or more of RMS, EQE, AIR (or so named) publish a range rather than a single point estimate, the mid point of the range will be taken as the loss estimate, from that source, as at the final settlement date.

### Master

### ‘Re-EX Contracts’

### Annual Futures

### Nationwide

### Q1 2006 Example

1. Territorial Scope

Losses occurring in the United States of America, being the 50 States of the Union and the District of Columbia, including its territories and possessions, including Puerto Rico and the US Virgin Islands.

2. Perils Covered

All losses defined as the sum of all losses with a Catastrophe number by Property Claims Service (PCS) which are as a result of either: Volcanic Disturbance/Eruption, Hurricane, Wind, Tropical Storm, Rainstorm, Thunderstorm, Storm, Tempest, Cyclone, Typhoon, Tornado, Tidal Wave, Tsunami, Flood, Hail, Winter Weather/Storm/Freeze, Ice Storm, Weight of Snow, Avalanche, Meteor/Asteroid Impact, Landslip, Mudslip, Subsidence, Bush Fire, Forest Fire, Wildland Fire, Lightning including fire and any other ensuing loss following any of the above perils.

3. Scope

The provision of these rules shall apply to all contracts bought or sold on the Exchange for cash settlement based on the cumulative loss estimates for the period of the contract.

4. Floating Price

The floating price to each contract is equal to the sum of the loss estimates for the contract period. Loss Estimates will be provided to NYMEX by Re-EX who will utilize the loss estimate amounts as provided by Property Claims Service (PCS). No changes will be made to the loss estimates by Re-EX who will provide individual and cumulative loss estimates.

5. Contract Quantity and Value

The contract quantity shall be USD 1,000. Each contract shall be valued as the contract quantity multiplied by the settlement price

6. Contract Months

Trading shall be conducted in contracts for the calendar year 2006 in respect of all Losses as defined in Perils Covered above occurring during the period 1 Jan. 2006 to 31 Mar. 2006 both days inclusive, Local Standard Time, at the place where the loss occurs.

7. Prices and Fluctuation.

Prices shall be quoted in US dollars per USD 10,000,000 of losses during the contract period. The minimum price fluctuation shall be $0.01 per $10,000,000 of losses. There shall be no maximum price fluctuation

8. Termination of Trading

Trading shall cease 17.45 EST 30 Sep. 2006, in respect of losses occurring during the period 1 Jan. 2006 to 31 Mar. 2006 both days inclusive, Local Standard Time, at the place where the loss occurs.

9. Final Settlement

Delivery under the contract shall be by cash settlement. The final settlement price will be the cumulative losses for the contract period as at 12.00 pm EST 2 Oct. 2006.

10. Deductions/Commissions

For cleared contracts $2.00 per side, for OTC contracts $2.50 per side.

11. Trading Hours

Sunday to Friday hr 18.00 to hr 17.45 EST

12. Loss in Progress

If this contract should expire whilst a loss is in progress, it is agreed that subject to the other conditions of this contract, all loss figures shall fail to the first date of the loss as provided by Re-EX, which shall be the first date of loss as stated by PCS.

13. Publication

The loss estimates shall be provided to NYMEX by ‘Re-EX’ who will use the ISO's (www.iso.com) Property Claims Services (PCS) figures, which will determine the final make up of loss to the contract.

14. Fallback Settlement

If the Property Claims Service is discontinued or materially changes its methodology in a way that it makes it unsuitable for the purpose intended, then NYMEX will calculate the settlement. The settlement shall be calculated at NYMEX's sole discretion and may use the following formula.

Any event that UMS, EQE, AIR (or so named) announce (publicly or to their Licensed clients only) a loss estimate will be used as the loss for the index calculation for the contracts. The loss estimates used will be the most recent announced by (MS, EQE, AIR (or so named) on or prior to the close of the contract. In the event that more than one of or (MS, EQE, AIR (or so named) announce a loss estimate, the loss used for calculation of the index will be a simple average of the estimate for each of RMS, EQE, AIR (or so named) who publish. In the event that one or more of RMS, EQE, AIR (or so named) publish a range rather than a single point estimate, the mid point of the range will be taken as the loss estimate, from that source, as at the final settlement date.

All other terms and conditions as per ISDA agreement

### Master

### ‘Re-EX Contracts’

### Annual Futures

### Europe

### 2006 Example

1. Territorial Scope

Europe being:

Albania, Andorra, Armenia, Austria, Azerbijan, Belarus, Belgium, Bosnia and Herzegovina, Bulgaria, Croatia, Cyprus, the Czech Republic, Denmark, Estonia, Faeroe Islands, Finland, France, Georgia, Germany, Gibraltar, Greece, Hungary, Iceland, Ireland, Italy, Jan Mayen, Latvia, Liechtenstein, Lithuania, Luxembourg, Macedonia, Malta, Moldova, Monaco, Montenegro, Netherlands, Norway, Poland, Portugal, Romania, Russia, San Marino, Serbia, Slovakia, Slovenia, Spain, Svalbard, Sweden, Switzerland, Turkey, the Ukraine and the United Kingdom (together with the Channel Islands and the Isle of Man), Vatican City and/or any other names by which such territories may become known

2. Perils Covered

All losses defined as the sum of all losses with a Catastrophe number by Property Claims Service (PCS) which are as a result of either: Volcanic Disturbance/Eruption, Hurricane, Wind, Tropical Storm, Rainstorm, Thunderstorm, Storm, Tempest, Cyclone, Typhoon, Tornado, Tidal Wave, Tsunami, Flood, Hail, Winter Weather/Storm/Freeze, Ice Storm, Weight of Snow, Avalanche, Meteor/Asteroid Impact, Landslip, Mudslip, Subsidence, Bush Fire, Forest Fire, Wildland Fire, Lightning including fire and any other ensuing loss following any of the above perils.

3. Scope

The provision of these rules shall apply to all contracts bought or sold on the Exchange for cash settlement based on the cumulative loss estimates for the period of the contract.

4. Floating Price

The floating price to each contract is equal to the sum of the loss estimates for the contract period. Loss Estimates will be provided to NYMEX by Re-EX who will utilize the loss estimate amounts as provided by Property Claims Service (PCS). No changes will be made to the loss estimates by Re-EX who will provide individual and cumulative loss estimates.

5. Contract Quantity and Value

The contract quantity shall be USD 1,000. Each contract shall be valued as the contract quantity multiplied by the settlement price

6. Contract Months

Trading shall be conducted in contracts for the calendar year 2006 in respect of all Losses as defined in Perils Covered above occurring during the period 1 Jan. 2006 to 31 Dec. 2006 both days inclusive, Local Standard Time at the place where the loss occurs.

7. Prices and Fluctuation.

Prices shall be quoted in US dollars per USD10,000,000 of losses during the contract period. The minimum price fluctuation shall be $0.01 per $10,000,000 of losses. There shall be no maximum price fluctuation

8. Termination of Trading

Trading shall cease 17.45 EST 30 Jun. 2007, in respect of losses occurring during the period 1 Jan. 2006 to 31 Dec. 2006 both days inclusive, Local Standard Time at the place where the loss occurs.

9. Final Settlement

Delivery under the contract shall be by cash settlement. The final settlement price will be the cumulative losses for the contract period as at 12.00 pm EST 2 Jul. 2007.

10. Deductions/Commissions

For cleared contracts $2.00 per side, for OTC contracts $2.50 per side.

11. Trading Hours

Sunday to Friday hr 18.00 to hr 17.45 EST

12. Loss in Progress

If this contract should expire whilst a loss is in progress, it is agreed that subject to the other conditions of this contract, all loss figures shall fall to the first date of the loss as provided by Re-EX, which shall be the first date of loss as stated by PCS.

13. Publication

The loss estimates shall be provided to NYMEX by ‘Re-EX’ who will use the ISO's (www.iso.com) Property Claims Services (PCS) figures, which will determine the final make up of loss to the contract.

14. Fallback Settlement

If the Property Claims Service is discontinued or materially changes its methodology in a way that it makes it unsuitable for the purpose intended, then NYMEX will calculate the settlement. The settlement shall be calculated at NYMEX's sole discretion and may use the following formula.

Any event that RS, EQE, AIR (or so named) announce (publicly or to their Licensed clients only) a loss estimate will be used as the loss for the index calculation for the contracts. The loss estimates used will be the most recent announced by RMS, EQE, AIR (or so named) on or prior to the close of the contract. In the event that more than one of or RMS, EQE, AIR (or so named) announce a loss estimate, the loss used for calculation of the index will be a simple average of the estimate for each of RMS, EQE, AIR (or so named) who publish. In the event that one or more of RMS, EQE, AIR (or so named) publish a range rather than a single point estimate, the mid point of the range will be taken as the loss estimate, from that source, as at the final settlement date.

All other terms and conditions as per ISDA agreement

### Master

### ‘Re-EX Contracts’

### Annual Futures

### Japan

### 2006 Example

1. Territorial Scope

Japan

2. Perils Covered

All losses defined as the sum of all losses with a Catastrophe number by Property Claims Service (PCS) which are as a result of either: Volcanic Disturbance/Eruption, Hurricane, Wind, Tropical Storm, Rainstorm, Thunderstorm, Storm, Tempest, Cyclone, Typhoon, Tornado, Tidal Wave, Tsunami, Flood, Hail, Winter Weather/Storm/Freeze, Ice Storm, Weight of Snow, Avalanche, Meteor/Asteroid Impact, Landslip, Mudslip, Subsidence, Bush Fire, Forest Fire, Wildland Fire, Lightning including fire and any other ensuing loss following any of the above perils.

3. Scope

The provision of these rules shall apply to all contracts bought or sold on the Exchange for cash settlement based on the cumulative loss estimates for the period of the contract.

4. Floating Price

The floating price to each contract is equal to the sum of the loss estimates for the contract period. Loss Estimates will be provided to NYMEX by Re-EX who will utilize the loss estimate amounts as provided by Property Claims Service (PCS). No changes will be made to the loss estimates by Re-EX who will provide individual and cumulative loss estimates.

5. Contract Quantity and Value

The contract quantity shall be USD 1,000. Each contract shall be valued as the contract quantity multiplied by the settlement price

6. Contract Months

Trading shall be conducted in contracts for the calendar year 2006 in respect of all Losses as defined in Perils Covered above occurring during the period 1 Jan. 2006 to 31 Dec. 2006 both days inclusive, Local Standard Time at the place where the loss occurs.

7. Prices and Fluctuation.

Prices shall be quoted in US dollars per USD 10,000,000 of losses during the contract period. The minimum price fluctuation shall be $0.01 per $10,000,000 of losses. There shall be no maximum price fluctuation

8. Termination of Trading

Trading shall cease 17.45 EST 30 Jun. 2007, in respect of losses occurring during the period 1 Jan. 2006 to 31 Dec. 2006 both days inclusive, Local Standard Time at the place where the loss occurs.

9. Final Settlement

Delivery under the contract shall be by cash settlement. The final settlement price will be the cumulative losses for the contract period as at 12.00 pm EST 2 Jul. 2007.

10. Deductions/Commissions

For cleared contracts $2.00 per side, for OTC contracts $2.50 per side.

11. Trading Hours

Sunday to Friday hr 18.00 to hr 17.45 EST

12. Loss in Progress

If this contract should expire whilst a loss is in progress, it is agreed that subject to the other conditions of this contract, all loss figures shall fall to the first date of the loss as provided by Re-EX, which shall be the first date of loss as stated by PCS.

13. Publication

The loss estimates shall be provided to NYMEX by ‘Re-EX’ who will use the ISO's (www.iso.com) Property Claims Services (PCS) figures, which will determine the final make up of loss to the contract.

14. Fallback Settlement

If the Property Claims Service is discontinued or materially changes its methodology in a way that it makes it unsuitable for the purpose intended, then NYMEX will calculate the settlement. The settlement shall be calculated at NYMEX's sole discretion and may use the following formula.

Any event that RMS, EQE, AIR (or so named) announce (publicly or to their Licensed clients only) a loss estimate will be used as the loss for the index calculation for the contracts. The loss estimates used will be the most recent announced by RMS, EQE, AIR (or so named) on or prior to the close of the contract. In the event that more than one of or RMS, EQE, AIR (or so named) announce a loss estimate, the loss used for calculation of the index will be a simple average of the estimate for each of RMS, EQE, AIR (or so named) who publish. In the event that one or more of RMS, EQE, AIR (or so named) publish a range rather than a single point estimate, the mid point of the range will be taken as the loss estimate, from that source, as at the final settlement date.

All other terms and conditions as per ISDA agreement

### Master

### ‘Re-EX Contracts’

### Annual Futures

### Modelled

### 2006 Example

1. Territorial Scope

USA (being the 50 States and the District of Columbia) its territories and possessions, including Puerto Rico and the US Virgin Islands.

2. Perils Covered

All losses defined as the sum of all losses that are estimated by either RMS, EQE, AIR (or so named) which are as a result of either: Volcanic Disturbance/Eruption, Hurricane, Wind, Tropical Storm, Rainstorm, Thunderstorm, Storm, Tempest, Cyclone, Typhoon, Tornado, Tidal Wave, Tsunami, Flood, Hail, Winter Weather/Storm/Freeze, Ice Storm, Weight of Snow, Avalanche, Meteor/Asteroid Impact, Landslip, Mudslip, Subsidence, Bush Fire, Forest Fire, Wildland Fire, Lightning including fire and any other ensuing loss following any of the above perils.

3. Scope

The provision of these rules shall apply to all contracts bought or sold on the Exchange for cash settlement based on the cumulative loss estimates for the period of the contract.

4. Floating Price

The floating price to each contract is equal to the sum of the loss estimates for the contract period. Loss Estimates will be provided to NYMEX by Re-EX who will utilize the loss estimate amounts as provided by RMS, EQE, AIR (or so named). No changes will be made to the loss estimates by Re-EX who will provide individual and cumulative loss estimates.

5. Contract Quantity and Value

The contract quantity shall be USD 10.00. Each contract shall be valued as the contract quantity multiplied by the settlement price

6. Contract Months

Trading shall be conducted in contracts for the calendar year 2006 in respect of all Losses as defined in Perils Covered above occurring during the period 1 Jan. 2006 to 31 Dec. 2006 both days inclusive, Local Standard Time at the place where the loss occurs.

7. Prices and Fluctuation.

Prices shall be quoted in US dollars per USD 10,000,000 of losses during the contract period. The minimum price fluctuation shall be $1.00 per $10,000,000 of losses. There shall be no maximum price fluctuation

8. Termination of Trading

Trading shall cease 17.45 EST 30 Jun. 2007, in respect of losses occurring during the period 1 Jan. 2006 to 31 Dec. 2006 both days inclusive, Local Standard Time at the place where the loss occurs.

9. Final Settlement

Delivery under the contract shall be by cash settlement. The final settlement price will be the cumulative losses for the contract period as at 12.00 pm EST 2 Jul. 2007.

10. Deductions/Commissions For cleared contracts $2.00 per side, for OTC contracts $2.50 per side,

11. Trading Hours

Sunday to Friday hr 18.00 to hr 17.45 EST

12. Loss in Progress

If this contract should expire whilst a loss is in progress, it is agreed that subject to the other conditions of this contract, all loss figures shall fall to the first date of the loss as provided by Re-EX, which shall be the first date of loss as stated by either RMS, EQE, AIR (or so named)

13. Publication

The loss estimates shall be provided to NYMEX by ‘Re-EX’ who will take any event that RMS, EQE, AIR (or so named) announce (publicly or to their Licensed clients only) a loss estimate will be used as the loss for the index calculation for the contracts. The loss estimates used will be the most recent announced by RMS, EQE, AIR (or so named) on or prior to the close of the contract. In the event that more than one of or RMS, EQE, AIR (or so named) announce a loss estimate, the loss used for calculation of the index will be a simple average of the estimate for each of RMS, EQE, AIR (or so named) who publish. In the event that one or more of US, EQE, AIR (or so named) publish a range rather than a single point estimate, the mid point of the range will be taken as the loss estimate, from that source, as at the final settlement date.

All other terms and conditions as per ISDA agreement

### Florida Only National Property Catastrophe Futures Contract Example

### XXX. 01 Scope

### XXX. 02 Time Reference

### XXX. 03 National Property Catastrophe Futures

### XXX. 04 Contract Value

### XXX. 05 Prices & Fluctuations

### XXX. 06 Trading Hours

### XXX. 07 Contract Months

### XXX. 08 Termination of Trading

### XXX. 09 Final Settlement

### XXX. 01 Scope

The provisions of these rules shall apply to all contracts bought or sold on the Exchange for cash settlement based on the ‘Re-EX Index.

### XXX. 02 Time Reference

For purposes of these Rules, unless otherwise specified, times referred to herein shall refer to and indicate the prevailing time in New York.

### XXX. 03 Floating Price For National Property Catastrophe Futures

The Floating Price for each contract month is equal to the sum of the Florida Loss Estimates divided by $10 million for the calendar year provided by the ‘Re-Ex Index (‘Re-Ex’)

### XXX. 04 Contract Value

The contract value is the Florida I Property Catastrophe Futures multiplied by $10.

### XXX. 05 Prices & Fluctuations

Prices shall be quoted in U.S. dollars and cents per $10 million of losses. The minimum price fluctuation shall be $0.01 per $10 million in losses ($10.00 per contract). There shall be no maximum price fluctuation.

### XXX. 06 Trading Hours

The contract is available for trading on the CME Clobex trading platform from 6:00 PM Sundays through 5:15 PM Fridays, with a 45-minute break each day between 5:15 PM and 6:00 PM.

Off-Exchange transactions can be submitted solely for clearing to the NYMEX ClearPort® clearing website from 6:00 PM Sundays until 5:15 PM Fridays, with a 45 minute break between 5:15 and 6:00 PM Mondays through Thursdays.

### XXX. 07 Contracts Months

Trading shall be conducted in contracts in such months as shall be determined by the Board of Directors.

### XXX. 08 Termination of Trading

Trading in the current month shall cease on the last business day of the March month following the January through December loss year.

### XXX. 09 Final Settlement

Delivery under the contract shall be by cash settlement. Final settlement following termination of trading for a contract will be based on the Index value as determined by ‘Re-Ex’

### Florida Property Catastrophe Options Contract

xxx.01 Expiration of National Property Catastrophe Option Contract

A Florida Property Catastrophe option contract on the Exchange shall expire at the close of trading on the final settlement day of the Florida 1 Property Futures Contract The expiration date shall be announced prior to the listing of the option contract.

xxx.02 Trading Unit for National Property Catastrophe Option Contract

A Florida Property Catastrophe put option represents the difference between the strike price less the ‘Re-Ex’ National index multiplied by $10. A Florida Property Catastrophe call option represents the difference between the ‘Re-Ex’ Florida index less the strike price multiplied by $1,0.

xxx.03 Trading Months for National Property Catastrophe Option Contract

Trading in Florida Property Catastrophe option contracts shall be conducted in the months as shall be determined by the Board of Directors. Trading shall commence on the day fixed by resolution of the Board of Directors.

xxx.04 Hours of Trading in National Property Catastrophe Option Contracts

The hours of trading in Florida Property Catastrophe option contracts on the Exchange shall be the same as the hours of trading for Florida Property Catastrophe futures contracts. All such trading shall take place on the trading floor of the Exchange within the hours prescribed by the Board.

xxx.05 Strike Prices for Florida Property Catastrophe Option Contracts
(A) Trading shall be conducted for options with strike prices in increments as set forth below. On the first business day of trading in an option contract month, trading shall be at the following strike prices,
(i) the previous day's settlement price for ‘RE-EX’ Florida Property Catastrophe futures contracts in the corresponding delivery month rounded off to the nearest five point increment strike price unless such settlement price is precisely midway between two five point increment strike prices in which case it shall be rounded off to the lower five point strike price and
(ii) the twenty, five point increment strike prices, which are twenty increments higher than the strike price described in (i) of this Rule xxx.05(A) and (iii) the twenty, five point increment strike prices which are twenty increments lower than the strike price described in (i) of this Rule xxx.05(A). and
(iv) an additional ten strike prices for both call and put options will be listed at ten point increments above the highest five point increment as described in (ii) of this Rule xxx.05 (A), beginning with the first available such strike that is evenly divisible by five and (v) an additional ten strike prices for both call and put options will be listed at ten point increments below the lowest five point increment as described in (iii) of this Rule xxx.05(A). beginning with the first available such strike that is evenly divisible by five.
(B) Thereafter, on any business day prior to the expiration of the option: (i) new consecutive five point increment striking prices for both puts and calls will be added such that at all times there will be at least twenty five point increment strike prices above and below the at-the-money strike price available for trading in all options contract months; and (ii) new 10 point increment strike prices will be added such that at all times there shall be ten, ten point strike prices, above and below the nearest five cent increment strike price. The at-of the-money strike price will be determined in accordance with the procedures set forth in Subsection (B) of this Rule xxx.05.

(C) Notwithstanding the provisions of subsections (A) and (B) of this Rule, if the Board determines that trading in Florida Property Catastrophe futures options will be facilitated thereby, the Board may, by resolution, change the increments between strike prices, the number of strike prices which shall be traded on the first day in any new option contract month, the number of new strike prices which will be introduced on each business day or the period preceding the expiration of a Florida Property Catastrophe futures option in which no new strike prices may be added.

xxx.06 Prices in Florida Property Catastrophe Option Contracts

Prices shall be quoted in dollars and cents per $100,000,000 of Loss as determined by ‘Re-Ex’ and prices shall be in multiples of one index point. A cabinet trade may occur at a price of 0.1 index points, or $1.00, however if it results in the liquidation of positions for both parties to the trade.

xxx.07 Absence of Price Fluctuation Limitations for Florida Property Catastrophe Option Contract

Trading in Florida 1 Property Catastrophe option contracts shall not be subject to price fluctuation limitations.

### Florida Property Catastrophe Binary Options Contract Example

xxx.01 Expiration of Florida PROPERTY CATASTROPHE Binary Option Contract

A Florida Property Catastrophe Binary Option contract on the Exchange shall expire at the close of trading on the final settlement day of the Florida Property Futures Contract. The expiration date shall be announced prior to the listing of the Binary Option contract.

xxx.02 Trading Unit for Florida Property Catastrophe Binary Option Contract

A Florida Property Catastrophe put Binary Option represents $5,000 if difference between the strike price is greater than the ‘Re-Ex’ Florida index or zero if the Florida 1 Property Catastrophe the strike price is less than the ‘Re-Ex’ Florida 1 index. A Florida Property Catastrophe call Binary Option represents $5,000 if difference between the strike price is less than the ‘Re-Ex’ National index or zero if the Florida 1 Property Catastrophe the strike price is greater than the ‘Re-Ex’ National index.

xxx.03 Trading Months for Florida Property Catastrophe Binary Option Contract Trading in Florida Property Catastrophe Binary Option contracts shall be conducted in the months as shall be determined by the Board of Directors. Trading shall commence on the day fixed by resolution of the Board of Directors.
xxx.04 Hours of Trading in Florida Property Catastrophe Binary Option Contracts The hours of trading in Florida Property Catastrophe Binary Option contracts on the Exchange shall be the same as the hours of trading for Florida Property Catastrophe futures contracts. All such trading shall take place on the trading floor of the Exchange within the hours prescribed by the Board.
xxx.05 Strike Prices for Florida Property Catastrophe Binary Option Contracts
(A) Trading shall be conducted for options with strike prices in increments as set forth below. (On the first business day of trading in an option contract month, trading shall be at the following strike prices: (i) the previous day's settlement price for Florida 1 Property Catastrophe futures contracts in the corresponding delivery month divided by 10 million (10.000,000) rounded off to the nearest five point increment strike price unless such settlement price is precisely midway between two five point increment strike prices in which case it shall be rounded off to the lower five point strike price and (ii) the twenty fifty-cent increment strike prices which are twenty increments higher than the strike price described in (i) of this Rule xxx.05(A) and (iii) the twenty, five point increment strike prices which are twenty increments lower than the strike price described in (i) of this Rule xxx.05(A). and (iv) an additional ten strike prices for both call and put options will be listed at ten point increments above the highest five point increment as described in (ii) of this Rule xxx.05 (A), beginning with the first available such strike that is evenly divisible by five and (v) an additional ten strike prices for both call and put options will be listed at ten point increments below the lowest fifty-cent increment as described in (iii) of this Rule xxx.05(A), beginning with the first available such strike that is evenly divisible by five.
(B) Thereafter, on any business day prior to the expiration of the option: (i) new consecutive fifty-cent increment striking prices for both puts and calls will be added such that at all times there will be at least twenty five point increment strike prices above and below the at-the-money strike price available for trading in all options contract months; and (ii) new 10 point increment strike prices will be added such that at all times there shall be ten ten point strike prices above and below the nearest five cent increment strike price. The at-of-the-money strike price will be determined in accordance with the procedures set forth in Subsection (B) of this Rule xxx.05.
(C) Notwithstanding the provisions of subsections (A) and (B) of this Rule, if the Board determines that trading in Florida Property Catastrophe futures options will be facilitated thereby, the Board may, by resolution, change the increments between strike prices, the number of strike prices which shall be traded on the first day in any new option contract month, the number of new strike prices which will be introduced on each business day or the period preceding the expiration of a Florida Property Catastrophe futures option in which no new strike prices may be added.
   xxx.06 Prices in Florida Property Catastrophe Binary Option Contracts

Prices shall be quoted in dollars and cents per barrel and prices shall be in multiples of 1 index point. A cabinet trade may occur at a price of 0.1 index points, or $1.00, however, if it results in the liquidation of positions for both parties to the trade.
xxx.07 Absence of Price Fluctuation Limitations for National Property Catastrophe Binary Option Contract

Trading in National Property Catastrophe Binary Option contracts shall not be subject to price fluctuation limitations.

### Individually Named Storms National Property Catastrophe Futures Contract Example

### XXX. 01 Scope

### XXX. 02 Time Reference

### XXX. 03 National Property Catastrophe Futures

### XXX. 04 Contract Value

### XXX. 05 Prices & Fluctuations

### XXX. 06 Trading Hours

### XXX. 07 Contract Months

### XXX. 08 Termination of Trading

### XXX. 09 Final Settlement

### XXX. 01 Scope

The provisions of these rules shall apply to all contracts bought or sold on the Exchange for cash settlement based on the Re-EX Index.

### XXX. 02 Time Reference

For purposes of these Rules, unless otherwise specified. times referred to herein shall refer to and indicate the prevailing time in New York.

XXX. 03 Floating Price For Individually Named Storms Property Catastrophe Futures The Floating Price for each contract month is equal to the sum of the Individually Named Storms Loss Estimates divided by $10 million for the calendar year provided by the ‘Re-Ex Index (‘Re-Ex’)

### XXX. 04 Contract Value

The contract value is the Individually Named Storms Property Catastrophe Futures multiplied by $10.

### XXX. 05 Prices & Fluctuations

Prices shall be quoted in U.S. dollars and cents per $10 million of losses. The minimum price fluctuation shall be $0.01 per $10 million in losses ($10.00 per contract). There shall be no maximum price fluctuation.

### XXX. 06 Trading Hours

The contract is available for trading on the CME Globex® trading platform from 6:00 PM Sundays through 5:15 PM Fridays, with a 45-minute break each day between 5:15 PM and 6:00 PM.

Off-Exchange transactions can be submitted solely for clearing to the NYMEX ClearPort® clearing website from 6:00 PM Sundays until 5:15 PM Fridays, with a 45 minute break between 5:15 and 6:00 PM Mondays through Thursdays.

### XXX. 07 Contracts Months

Trading shall be conducted in contracts in such months as shall be determined by the Board of Directors.

### XXX. 08 Termination of Trading

Trading in the current month shall cease on the last business day of the March month following the January through December loss year.

### XXX. 09 Final Settlement

Delivery under the contract shall be by cash settlement. Final settlement following termination of trading for a contract will be based on the Index value as determined by ‘Re-Ex’

### Individually Named Storms Property Catastrophe Options Contract Example

xxx.01 Expiration of Individually Named Storms Property Catastrophe Option Contract

An Individually Named Storms Property Catastrophe option contract on the Exchange shall expire at the close of trading on the final settlement day of the Individually Named Storms Property Futures Contract The expiration date shall be announced prior to the listing of the option contract.

xxx.02 Trading Unit for Individually Named Storms Property Catastrophe Option Contract

An Individually Named Storms 1 Property Catastrophe put option represents the difference between the strike price less the ‘Re-Ex’ Individually Named Storms index multiplied by $10. An Individually Named Storms 1 Property Catastrophe call option represents the difference between the ‘Re-Ex’ national index less the strike price multiplied by $10.

xxx.03 Trading Months for Individually Named Storms Property Catastrophe Option Contract

Trading in Individually Named Storms Property Catastrophe option contracts shall be conducted in the months as shall be determined by the Board of Directors. Trading shall commence on the day fixed by resolution of the Board of Directors.

xxx.04 Hours of Trading in Individually Named Storms Property Catastrophe Option

### Contracts

The hours of trading in Individually Named Storms Property Catastrophe option contracts on the Exchange shall be the same as the hours of trading for Individually Named Storms Property Catastrophe futures contracts. All such trading shall take place on the trading floor of the Exchange within the hours prescribed by the Board.

xxx.05 Strike Prices for Individually Named Storms Property Catastrophe Option Contracts
(A) Trading, shall be conducted for options with strike prices in increments as set forth below. On the first business day of trading in an option contract month trading shall be at the following strike prices:
(i) the previous day's settlement price for ‘RE-EX’ Individually Named Storms 1 Property Catastrophe futures contracts in the corresponding delivery month rounded off to the nearest five point increment strike price unless such settlement price is precisely midway between two five point increment strike prices in which case it shall be rounded off to the lower five point strike price and
(ii) the twenty, five point increment strike prices, which are twenty increments higher than the strike price described in (i) of this Rule xxx.05(A) and (iii) the twenty, five point increment strike prices which are twenty increments lower than the strike price described in (i) of this Rule xxx.05(A). and
(iv) an additional ten strike prices for both call and put options will be listed at ten point increments above the highest five point increment as described in (ii) of this Rule xxx.05 (A), beginning with the first available such strike that is evenly divisible by five and
(v) an additional ten strike prices for both call and put options will be listed at ten point increments below the lowest five point increment as described in (iii) of this Rule xxx.05(A), beginning with the first available such strike that is evenly divisible by five.
(B) Thereafter, on any business day prior to the expiration of the option: (i) new consecutive five point increment striking prices for both puts and calls will be added such that at all times there will be at least twenty five point increment strike prices above and below the at-the-money strike price available for trading in all options contract months; and (ii) new 10 point increment strike prices will be added such that at all times there shall be ten, ten point strike prices, above and below the nearest five cent increment strike price. The at-of-the-money strike price will be determined in accordance with the procedures set forth in Subsection (B) of this Rule xxx.05.
(C) Notwithstanding the provisions of subsections (A) and (B) of this Rule, if the Board determines that trading in National Property Catastrophe futures options will be facilitated thereby, the Board may, by resolution, change the increments between strike prices, the number of strike prices which shall be traded on the first day in any new option contract month, the number of new strike prices which will be introduced on each business day or the period preceding the expiration of a National Property Catastrophe futures option in which no new strike prices may be added.
   xxx.06 Prices in Individually Named Storms Property Catastrophe Option Contracts

Prices shall be quoted in dollars and cents per $100,000,000 of Loss as determined by ‘Re-Ex’ and prices shall be in multiples of one index point. A cabinet trade may occur at a price of 0.1 index points, or $1.00, however, if it results in the liquidation of positions for both parties to the trade.

xxx.07 Absence of Price Fluctuation Limitations for Individually Named Storms Property Catastrophe Option Contract

Trading in Individually Named Storms Property Catastrophe option contracts shall not be subject to price fluctuation limitations.

### Individually Named Storms Property Catastrophe Binary Options Contract Example

xxx.01 Expiration of Individually Named Storms Property Catastrophe-Binary Option Contract

A Individually Named Storms Property Catastrophe Binary Option contract on the Exchange shall expire at the close of trading on the final settlement day of the Individually Named Storms Property Futures Contract. The expiration date shall be announced prior to the listing of the Binary Option contract.

xxx.02 Trading Unit for Individually Named Storms Property Catastrophe Binary Option Contract

A Individually Named Storms Property Catastrophe put Binary Option represents $5,000 if difference between the strike price is greater than the ‘Re-Ex’ National index or zero if the Individually Named Storms Property Catastrophe the strike price is less than the ‘Re-Ex’ National index. A Individually Named Storms Property Catastrophe call Binary Option represents $5.000 if difference between the strike price is less than the ‘Re-Ex’ National index or zero if the Individually Named Storms Property Catastrophe the strike price is greater than the ‘Re-Ex’ National index.

xxx.03 Trading Months for Individually Named Storms Property Catastrophe Binary Option Contract

Trading in Individually Named Storms 1 Property Catastrophe Binary Option contracts shall be conducted in the months as shall be determined by the Board of Directors. Trading shall commence on the day fixed by resolution of the Board of Directors.

xxx.04 Hours of Trading in Individually Named Storms Property Catastrophe Binary Option Contracts

The hours of trading in Individually Named Storms Property Catastrophe Binary Option contracts on the Exchange shall be the same as the hours of trading for Individually Named Storms 1 Property Catastrophe futures contracts. All such trading shall take place on the trading floor of the Exchange within the hours prescribed by the Board.

xxx.05 Strike Prices for Individually Named Storms Property Catastrophe Binary Option Contracts
(A) Trading shall be conducted for options with strike prices in increments as set forth below. On the first business day of trading in an option contract month, trading shall be at the following strike prices: (i) the previous day's settlement price for Individually Named Storms Property Catastrophe futures contracts in the corresponding delivery month divided by 10 million (10,000,000) rounded off to the nearest five point increment strike price unless such settlement price is precisely midway between two five point increment strike prices in which case it shall be rounded off to the lower five point strike price and (ii) the twenty fifty-cent increment strike prices which are twenty increments higher than the strike price described in (i) of this Rule xxx.05(A) and (iii) the twenty, five point increment strike prices which are twenty increments lower than the strike price described in (i) of this Rule xxx.05(A). and (iv) an additional ten strike prices for both call and put options will be listed at ten point increments above the highest five point increment as described in (ii) of this Rule xxx.05 (A), beginning with the first available such strike that is evenly divisible by five and (v) an additional ten strike prices for both call and put options will be listed at ten point increments below the lowest fifty-cent increment as described in (iii) of this Rule xxx.05(A), beginning with the first available such strike that is evenly divisible by five.
(B) Thereafter, on any business day prior to the expiration of the option: (i) new consecutive fifty-cent increment striking prices for both puts and calls will be added such that at all times there will be at least twenty five point increment strike prices above and below the at-the-money strike price available for trading in all options contract months; and (ii) new 10 point increment strike prices will be added such that at all times there shall be ten point strike prices above and below the nearest five cent increment strike price. The at-of-the-money strike price will be determined in accordance with the procedures set forth in Subsection (B) of this Rule xxx.05.
(C) Notwithstanding the provisions of subsections (A) and (B) of this Rule, if the Board determines that trading in Individually Named Storms Property Catastrophe futures options with the facilitated thereby, the Board may, by resolution, change the increments between strike prices, the number of strike prices which shall be traded on the first day in any new option contract month. the number of new strike prices which will be introduced on each business day or the period preceding the expiration of a Individually Named Storms 1 Property Catastrophe futures option in which no new strike prices may be added.
   xxx.06 Prices in Individually Named Storms Property Catastrophe Binary Option Contracts

Prices shall be quoted in dollars and cents per barrel and prices shall be in multiples of 1 index point. A cabinet trade may occur at a price of 0.1 index points, or $1.00, however, if it results in the liquidation of positions for both parties to the trade.

xxx.07 Absence of Price Fluctuation Limitations for Individually Named Storms Property Catastrophe Binary Option Contract

Trading in Individually Named Storms 1 Property Catastrophe Binary Option contracts shall not be subject to price fluctuation limitations.

### US National Property Catastrophe Futures Contract Example

### XXX. 01 Scope

### XXX. 02 Time Reference

### XXX. 03 National Property Catastrophe Futures

### XXX. 04 Contract Value

### XXX. 05 Prices & Fluctuations

### XXX. 06 Trading flours

### XXX. 07 Contract Months

### XXX. 08 Termination of Trading

### XXX. 09 Final Settlement

### XXX. 01 Scope

The provisions of these rules shall apply to all contracts bought or sold on the Exchange for cash settlement based on the Re-EX Index.

### XXX. 02 Time Reference

For purposes of these Rules, unless otherwise specified, times referred to herein shall refer to and indicate the prevailing time in New York.

### XXX. 03 Floating Price For National Property Catastrophe Futures

The Floating Price for each contract month is equal to the sum of the National Loss Estimates divided by $10 million for the calendar year provided by the ‘Re-Ex Index (‘Re-Ex’)

### XXX. 04 Contract Value The contract value is the National Property Catastrophe Futures multiplied by $10.

### XXX. 05 Prices & Fluctuations

Prices shall be quoted in U.S. dollars and cents per $10 million of losses. The minimum price fluctuation shall be $0.01 per $10 million in losses ($10.00 per contract). There shall be no maximum price fluctuation.

### XXX. 06 Trading Hours

The contract is available for trading on the CME Globex® trading platform from 6:00 PM Sundays through 5:15 PM Fridays, with a 45-minute break each day between 5:15 PM and 6:00 PM.

Off-Exchange transactions can be submitted solely for clearing to the NYMEX ClearPort® clearing website from 6:00 PM Sundays until 5:15 PM Fridays, with a 45 minute break between 5:15 and 6:00 PM Mondays through Thursdays.

XXX. 07 Contracts Months

Trading shall be conducted in contracts in such months as shall be determined by the Board of Directors.

### XXX. 08 Termination of Trading

Trading in the current month shall cease on the last business day of the March month following the January through December loss year.

XXX. 09 Final Settlement Delivery under the contract shall be by cash settlement. Final settlement following termination of trading for a contract will be based on the Index value as determined by ‘Re-Ex’

### National Property Catastrophe Options Contract Example

xxx.01 Expiration of National Property Catastrophe Option Contract

A National Property Catastrophe option contract on the Exchange shall expire at the close of trading on the final settlement day of the National Property Futures Contract The expiration date shall be announced prior to the listing of the option contract.

xxx.02 Trading Unit for National Property Catastrophe Option Contract

A National Property Catastrophe put option represents the difference between the strike price less the “Re-Ex” National index multiplied by $10. A. National Property Catastrophe call option represents the difference between the ‘Re-Ex’ national index less the strike price multiplied by $1,0.

xxx.03 Trading Months for National Property Catastrophe Option Contract

Trading in National Property Catastrophe option contracts shall be conducted in the months as shall be determined by the Board of Directors. Trading shall commence on the day fixed by resolution of the Board of Directors.

xxx.04 Hours of Trading in National Property Catastrophe Option Contracts

The hours of trading in National Property Catastrophe option contracts on the Exchange shall be the same as the hours of trading for National Property Catastrophe futures contracts. All such trading shall take place on the trading floor of the Exchange within the hours prescribed by the Board.

xxx.05 Strike Prices for National Property Catastrophe Option Contracts
(A) Trading shall be conducted for options with strike prices in increments as set forth below. On the first business day of trading in an option contract month, trading shall be at the following strike prices:
(i) the previous day's settlement price for ‘RE-EX’ National Property Catastrophe futures contracts in the corresponding delivery month rounded off to the nearest five point increment strike price unless such settlement price is precisely midway between two five point increment strike prices in which case it shall be rounded off to the lower five point strike price and
(ii) the twenty, five point increment strike prices, which are twenty increments higher than the strike price described in (i) of this Rule xxx.05(A) and (iii) the twenty, five point increment strike prices which are twenty increments lower than the strike price described in (i) of this Rule xxx.05 (A), and
(iv) an additional ten strike prices for both call and put options will be listed at ten point increments above the highest five point increment as described in (ii) of this Rule xxx.05 (A), beginning with the first available such strike that is evenly divisible by five and
(v) an additional ten strike prices for both call and put options will be listed at ten point increments below the lowest five point increment as described in (iii) of this Rule xxx.05(A), beginning with the first available such strike that is evenly divisible by five,
(B) Thereafter. on any business day prior to the expiration of the option: (i) new consecutive five point increment striking prices for both puts and calls will be added such that at all times there will be at least twenty five point increment strike prices above and below the at-the-money strike price available for trading in all options contract months; and (ii) new 10 point increment strike prices will be added such that at all times there shall be ten, ten point strike prices, above and below the nearest five cent increment strike price. The at-of-the-money strike price will be determined in accordance with the procedures set forth in Subsection (B) of this Rule xxx.05.
(C) Notwithstanding the provisions of subsections (A) and (B) of this Rule, if the Board determines that trading in National Property Catastrophe futures options will be facilitated thereby, the Board may, by resolution, change the increments between strike prices, the number of strike prices which shall be traded on the first day in any new option contract month, the number of new strike prices which will be introduced on each business day or the period preceding the expiration of a National Property Catastrophe futures option in which no new strike prices may be added.
   xxx.06 Prices in National Property Catastrophe Option Contracts

Prices shall be quoted in dollars and cents per $100,000,000 of Loss as determined by ‘Re-Ex’ and prices shall be in multiples of one index point. A cabinet trade may occur at a price of 0.1 index points, or $1.00, however, if it results in the liquidation of positions for both parties to the trade.

xxx.07 Absence of Price Fluctuation Limitations for National Property Catastrophe Option Contract

Trading in National Property Catastrophe option contracts shall not be subject to price fluctuation limitations.

### National Property Catastrophe Binary Options Contract Example

xxx.01 Expiration of NATIONAL PROPERTY CATASTROPHE Binary Option Contract

A National Property Catastrophe Binary Option contract on the Exchange shall expire at the close of trading on the final settlement day of the National Property Futures Contract. The expiration date shall be announced prior to the listing of the Binary Option contract.

xxx.02 Trading Unit for National Property Catastrophe Binary Option Contract

A National Property Catastrophe put Binary Option represents $5,000 if difference between the strike price is greater than the ‘Re-Ex’ National index or zero if the National Property Catastrophe the strike price is less than the ‘Re-Ex’ National index. A National Property Catastrophe call Binary Option represents $5.000 if difference between the strike price is less than the “Re-Ex” National index or zero if the National Property Catastrophe the strike price is greater than the ‘Re-Ex’ National index.

xxx.03 Trading Months for National Property Catastrophe Binary Option Contract

Trading in National Property Catastrophe Binary Option contracts shall be conducted in the months as shall be determined by the Board of Directors. Trading shall commence on the day fixed by resolution of the Board of Directors.

xxx.04 Hours of Trading in National Property Catastrophe Binary Option Contracts

The hours of trading in National Property Catastrophe Binary Option contracts on the Exchange shall be the same as the hours of trading for National Property Catastrophe futures contracts. All such trading shall take place on the trading floor of the Exchange within the hours prescribed by the Board.

xxx.05 Strike Prices for National Property Catastrophe Binary Option Contracts
(A) Trading shall be conducted for options with strike prices in increments as set forth below On the first business day of trading in an option contract month, trading shall be at the following strike prices: (i) the previous day's settlement price for National Property Catastrophe futures contracts in the corresponding delivery month divided by 10 million (10,000,000) rounded off to the nearest five point increment strike price unless such settlement price is precisely midway between two five point increment strike prices in which case it shall be rounded off to the lower five point strike price and (ii) the twenty fifty-cent increment strike prices which are twenty increments higher than the strike price described in (i) of this Rule xxx.05(A) and (iii) the twenty, five point increment strike prices which are twenty increments lower than the strike price described in (i) of this Rule xxx.05(A). and (iv) an additional ten strike prices for both call and put options will be listed at ten point increments above the highest five point increment as described in (ii) of this Rule xxx.05 (A), beginning with the first available such strike that is evenly divisible by five and (v) an additional ten strike prices for both call and put options will be listed at ten point increments below the lowest fifty-cent increment as described in (iii) of this Rule xxx.05(A), beginning with the first available such strike that is evenly divisible by five.
(B) Thereafter, on any business day prior to the expiration of the option: (i) new consecutive fifty-cent increment striking prices for both puts and calls will be added such that at all times there will be at least twenty five point increment strike prices above and below the at-the-money strike price available for trading in all options contract months; and (ii) new 10 point increment strike prices will be added such that at all times there shall be ten ten point strike prices above and below the nearest five cent increment strike price. The at-of-the-money strike price will be determined in accordance with the procedures set forth in Subsection (B) of this Rule xxx.05.
(C) Notwithstanding the provisions of subsections (A) and (B) of this Rule, if the Board determines that trading in National Property Catastrophe futures options will be facilitated thereby, the Board may, by resolution, change the increments between strike prices, the number of strike prices which shall be traded on the first day in any new option contract month, the number of new strike prices which will be introduced on each business day or the period preceding the expiration of a National Property Catastrophe futures option in which no new strike prices may be added.
   xxx.06 Prices in National Property Catastrophe Binary Option Contracts Prices shall be quoted in dollars and cents per barrel and prices shall be in multiples of 1 index point. A cabinet trade may occur at a price of 0.1 index points, or $1.00, however, if it results in the liquidation of positions for both parties to the trade.
   xxx.07 Absence of Price Fluctuation Limitations for National Property Catastrophe Binary Option Contract

Trading in National Property Catastrophe Binary Option contracts shall not be subject to price fluctuation limitations.

### Texas To Maine Excluding Florida National Property Catastrophe Futures Contract Example

### XXX. 01 Scope

### XXX. 02 Time Reference

### XXX. 03 National Property Catastrophe Futures

### XXX. 04 Contract Value

### XXX. 05 Prices & Fluctuations

### XXX. 06 Trading Hours

### XXX. 07 Contract Months

### XXX. 08 Termination of Trading

### XXX. 09 Final Settlement

### XXX. 01 Scope

The provisions of these rules shall apply to all contracts bought or sold on the Exchange for cash settlement based on the ‘Re-EX Index.

### XXX. 02 Time Reference

For purposes of these Rules, unless otherwise specified, times referred to herein shall refer to and indicate the prevailing time in New York.

### XXX. 03 Floating Price For Texas to Maine Excluding Florida Property Catastrophe Futures

The Floating Price for each contract month is equal to the sum of the Texas to Maine Excluding Florida Loss Estimates divided by $10 million for the calendar year provided by the ‘Re-Ex Index (‘Re-Ex’)

### XXX. 04 Contract Value

The contract value is the Texas to Maine Excluding Florida Property Catastrophe Futures multiplied by $10.

### XXX. 05 Prices & Fluctuations

Prices shall be quoted in U.S. dollars and cents per $10 million of losses. The minimum price fluctuation shall be $0.01 per $10 million in losses ($10.00 per contract). There shall be no maximum price fluctuation.

### XXX. 06 Trading Hours

The contract is available for trading on the CME Globex® trading platform from 6:00 PM Sundays through 5:15 PM Fridays, with a 45-minute break each day between 5:15 PM and 6:00 PM.

Off-Exchange transactions can be submitted solely for clearing to the NYMEX ClearPort® clearing website from 6:00 PM Sundays until 5:15 PM Fridays, with a 45 minute break between 5:15 and 6:00 PM Mondays through Thursdays.

### XXX. 07 Contracts Months

Trading shall be conducted in contracts in such months as shall be determined by the Board of Directors.

### XXX. 08 Termination of Trading

Trading in the current month shall cease on the last business day of the March month following the January through December loss year.

### XXX. 09 Final Settlement

Delivery under the contract shall be by cash settlement. Final settlement following termination of trading for a contract will be based on the Index value as determined by ‘Re-Ex’

### Texas to Maine Excluding Florida Property Catastrophe Options Contract Example

xxx.01 Expiration of National Property Catastrophe Option Contract

A National Property Catastrophe option contract on the Exchange shall expire at the close of trading on the final settlement day of the Texas to Maine Excluding Florida Property Futures Contract The expiration date shall be announced prior to the listing of the option contract.

xxx.02 Trading Unit for National Property Catastrophe Option Contract

A Texas to Maine Excluding Florida Property Catastrophe put option represents the difference between the strike price less the ‘Re-Ex’ National index multiplied by S10. A Texas to Maine Excluding Florida Property Catastrophe call option represents the difference between the ‘Re-Ex’ national index less the strike price multiplied by $1,0.

xxx.03 Trading Months for Texas to Maine Excluding Florida Property Catastrophe Option Contract

Trading in Texas to Maine Excluding Florida Property Catastrophe option contracts shall be conducted in the months as shall be determined by the Board of Directors. Trading shall commence on the day fixed by resolution of the Board of Directors.

xxx.04 Hours of Trading in Texas to Maine Excluding Florida Property Catastrophe Option Contracts

The hours of trading in Texas to Maine Excluding Florida 1 Property Catastrophe option contracts on the Exchange shall be the same as the hours of trading for Texas to Maine Excluding Florida 1 Property Catastrophe futures contracts. All such trading shall take place on the trading floor of the Exchange within the hours prescribed by the Board.

xxx.05 Strike Prices for Texas to Maine Excluding Florida Property Catastrophe Option Contracts
(A) Trading shall be conducted for options with strike prices in increments as set forth below. On the first business day of trading in an option contract month, trading shall be at the following strike prices:
(i) the previous day's settlement price for ‘RE-EX’ Texas to Maine Excluding Florida Property Catastrophe futures contracts in the corresponding delivery month rounded off to the nearest five point increment strike price unless such settlement price is precisely midway between two five point increment strike prices in which ease it shall be rounded off to the lower five point strike price and
(ii) the twenty, five point increment strike prices, which are twenty increments higher than the strike price described in (i) of this Rule xxx.05(A) and (iii) the twenty, five point increment strike prices which are twenty increments lower than the strike price described in (i) of this Rule xxx.05(A). and
(iv) an additional ten strike prices for both call and put options will be listed at ten point increments above the highest five point increment as described in (ii) of this Rule xxx.05 (A), beginning with the first available such strike that is evenly divisible by five and
(v) an additional ten strike prices for both call and put options will be listed at ten point increments below the lowest five point increment as described in (iii) of this Rule xxx.05(A), beginning with the first available such strike that is evenly divisible by five.
(B) Thereafter, on any business day prior to the expiration of the option: (i) new consecutive five point increment striking prices for both puts and calls will be added such that at all times there will be at least twenty five point increment strike prices above and below the at-the-money strike price available for trading in all options contract months; and (ii) new 10 point increment strike prices will be added such that at all times there shall be ten, ten point strike prices, above and below the nearest five cent increment strike price. The at-of-the-money strike price will be determined in accordance with the procedures set forth in Subsection (B) of this Rule xxx.05.
(C) Notwithstanding the provisions of subsections (A) and (B) of this Rule, if the Board determines that trading in Texas to Maine Excluding Florida Property Catastrophe futures options will be facilitated thereby, the Board may, by resolution, change the increments between strike prices, the number of strike prices which shall be traded on the first day in any new option contract month, the number of new strike prices which will be introduced on each business day or the period preceding the expiration of a Texas to Maine Excluding Florida Property Catastrophe futures option in which no new strike prices may be added.
   xxx.06 Prices in Texas to Maine Excluding Florida Property Catastrophe Option Contracts

Prices shall be quoted in dollars and cents per $100,000,000 of Loss as determined by ‘Re-Ex’ and prices shall be in multiples of one index point. A cabinet trade may occur at a price of 0.1 index points, or $1.00, however, if it results in the liquidation of positions for both parties to the trade.

xxx.07 Absence of Price Fluctuation Limitations for Texas to Maine Excluding Florida Property Catastrophe Option Contract

Trading in Texas to Maine Excluding Florida 1 Property Catastrophe option contracts shall not be subject to price fluctuation limitations.

### Texas To Maine Excluding Florida Property Catastrophe Binary Options Contract Example

xxx.01 Expiration of Texas to Maine Excluding Florida PROPERTY CATASTROPHE Binary Option Contract

A Texas to Maine Excluding Florida Property Catastrophe Binary Option contract on the Exchange shall expire at the close of trading on the final settlement day of the National Property Futures Contract. The expiration date shall be announced prior to the listing of the Binary Option contract.

xxx.02 Trading Unit for Texas to Maine Excluding Florida Property Catastrophe Binary Option Contract

A Texas to Maine Excluding Florida Property Catastrophe put Binary Option represents $5,000 if difference between the strike price is greater than the ‘Re-Ex’ Texas to Maine Excluding Florida 1 index or zero if the Texas to Maine Excluding Florida Property Catastrophe the strike price is less than the ‘Re-Ex’ National index. A Texas to Maine Excluding Florida 1 Property Catastrophe call Binary Option represents $5,000 if difference between the strike price is less than the ‘Re-Ex’ National index or zero if the Texas to Maine Excluding Florida Property Catastrophe the strike price is greater than the ‘Re-Ex’ National index.

xxx.03 Trading Months for Texas to Maine Excluding Florida Property Catastrophe Binary Option Contract

Trading in Texas to Maine Excluding Florida Property Catastrophe Binary Option contracts shall be conducted in the months as shall be determined by the Board of Directors. Trading shall commence on the day fixed by resolution of the Board of Directors.

xxx.04 Hours of Trading in Texas to Maine Excluding Florida Property Catastrophe Binary Option Contracts

The hours of trading in Texas to Maine Excluding Florida 1 Property Catastrophe Binary Option contracts on the Exchange shall be the same as the hours of trading for Texas to Maine Excluding Florida Property Catastrophe futures contracts. All such trading shall take place on the trading floor of the Exchange within the hours prescribed by the Board.

xxx.05 Strike Prices for Texas to Maine Excluding Florida Property Catastrophe Binary Option Contracts
(A) Trading shall be conducted for options with strike prices in increments as set forth below. On the first business day of trading in an option contract month, trading shall be at the following strike prices: (i) the previous day's settlement price for Texas to Maine Excluding Florida Property Catastrophe futures contracts in the corresponding delivery month divided by 10 million (10,000,000) rounded off to the nearest five point increment strike price unless such settlement price is precisely midway between two five point increment strike prices in which case it shall be rounded off to the lower five point strike price and (ii) the twenty fifty-cent increment strike prices which are twenty increments higher than the strike price described in (i) of this Rule xxx.05(A) and (iii) the twenty, five point increment strike prices which are twenty increments lower than the strike price described in (i) of this Rule xxx.05(A). and (iv) an additional ten strike prices for both call and put options will be listed at ten point increments above the highest five point increment as described in (ii) of this Rule xxx.05 (A), beginning with the first available such strike that is evenly divisible by five and (v) an additional ten strike prices for both call and put options will be listed at ten point increments below the lowest fifty-cent increment as described in (iii) of this Rule xxx.05(A), beginning with the first available such strike that is evenly divisible by five.
(B) Thereafter, on any business day prior to the expiration of the option: (i) new consecutive fifty-cent increment striking prices for both puts and calls will be added such that at all times there will be at least twenty five point increment strike prices above and below the at-the-money strike price available for trading in all options contract months; and (ii) new 10 point increment strike prices will be added such that at all times there shall be ten ten point strike prices above and below the nearest five cent increment strike price. The at-of-the-money strike price will be determined in accordance with the procedures set forth in Subsection (B) of this Rule xxx.05.
(C) Notwithstanding the provisions of subsections (A) and (B) of this Rule, if the Board determines that trading in Texas to Maine Excluding Florida Property Catastrophe futures options will be facilitated thereby, the Board may, by resolution, change the increments between strike prices, the number of strike prices which shall be traded on the first day in any new option contract month, the number of new strike prices which will be introduced on each business day or the period preceding the expiration of a National Property Catastrophe futures option in which no new strike prices may be added.
   xxx.06 Prices in Texas to Maine Excluding Florida Property Catastrophe Binary Option Contracts

Prices shall be quoted in dollars and cents per barrel and prices shall be in multiples of 1 index point. A cabinet trade may occur at a price of 0.1 index points, or $1.00, however, if it results in the liquidation of positions for both parties to the trade.

xxx.07 Absence of Price Fluctuation Limitations for Texas to Maine Excluding Florida Property Catastrophe Binary Option Contract

Trading in Texas to Maine Excluding Florida 1 Property Catastrophe Binary Option contracts shall not be subject to price fluctuation limitations.

### Texas To Louisiana Property Catastrophe Futures Contract Example

### XXX. 01 Scope

### XXX. 02 Time Reference

### XXX. 03 National Property Catastrophe Futures

### XXX. 04 Contract Value

### XXX. 05 Prices & Fluctuations

### XXX. 06 Trading Hours

### XXX. 07 Contract Months

### XXX. 08 Termination of Trading

### XXX. 09 Final Settlement

### XXX. 01 Scope

The provisions of these rules shall apply to all contracts bought or sold on the Exchange for cash settlement based on the ‘Re-EX Index.

### XXX. 02 Time Reference

For purposes of these Rules, unless otherwise specified, times referred to herein shall refer to and indicate the prevailing time in New York.

### XXX. 03 Floating Price For Texas to Louisiana Property Catastrophe Futures

The Floating Price for each contract month is equal to the sum of the Texas to Louisiana Loss Estimates divided by $10 million for the calendar year provided by the ‘Re-Ex Index (‘Re-Ex’)

### XXX. 04 Contract Value

The contract value is the Texas to Louisiana Property Catastrophe Futures multiplied by $10.

### XXX. 05 Prices & Fluctuations

Prices shall be quoted in U.S. dollars and cents per $10 million of losses. The minimum price fluctuation shall be $0.01 per $10 million in losses ($10.00 per contract). There shall be no maximum price fluctuation.

### XXX. 06 Trading Hours

The contract is available for trading on the CME Globex® trading platform from 6.00 PM Sundays through 5:15 PM Fridays, with a 45-minute break each day between 5:15 PM and 6:00 PM.

Off-Exchange transactions can be submitted solely for clearing to the NYMEX ClearPort® clearing website from 6:00 PM Sundays until 5:15 PM Fridays, with a 45 minute break between 5:15 and 6:00 PM Mondays through Thursdays.

### XXX. 07 Contracts Months

Trading shall be conducted in contracts in such months as shall be determined by the Board of Directors.

XXX. 08 Termination of Trading Trading in the current month shall cease on the last business day of the March month following the January through December loss year.

### XXX. 09 Final Settlement

Delivery under the contract shall be by cash settlement. Final settlement following termination of trading for a contract will be based on the Index value as determined by ‘Re-Ex’

### Texas To Louisiana Property Catastrophe Options Contract Example

xxx.01. Expiration of Texas to Louisiana Property Catastrophe Option Contract

A Texas to Louisiana Property Catastrophe option contract on the Exchange shall expire at the close of trading on the final settlement day of the Texas to Louisiana Property Futures Contract The expiration date shall be announced prior to the listing of the option contract.

xxx.02 Trading Unit for Texas to Louisiana Property Catastrophe Option Contract

A Texas to Louisiana Property Catastrophe put option represents the difference between the strike price less the ‘Re-Ex’ National index multiplied by $10. A Texas to Louisiana Property Catastrophe call option represents the difference between the ‘Re-Ex’ national index less the strike price multiplied by $1,0.

xxx.03 Trading Months for Texas to Louisiana Property Catastrophe Option Contract

Trading in Texas to Louisiana Property Catastrophe option contracts shall be conducted in the months as shall be determined by the Board of Directors. Trading shall commence on the day fixed by resolution of the Board of Directors.

xxx.04 Hours of Trading in Texas to Louisiana Property Catastrophe Option Contracts

The hours of trading in Texas to Louisiana 1 Property Catastrophe option contracts on the Exchange shall be the same as the hours of trading for Texas to Louisiana Property Catastrophe futures contracts. All such trading shall take place on the trading floor of the Exchange within the hours prescribed by the Board.

xxx.05 Strike Prices for Texas to Louisiana Property Catastrophe Option Contracts
(A) Trading shall be conducted for options with strike prices in increments as set forth below. On the first business day of trading in an option contract month, trading shall be at the following strike prices:
(i) the previous day's settlement price for ‘RE-EX’ Texas to Louisiana Property Catastrophe futures contracts in the corresponding delivery month rounded off to the nearest five point increment strike price unless such settlement price is precisely midway between two five point increment strike prices in which case it shall be rounded off to the lower five point strike price and
(ii) the twenty, five point increment strike prices, which are twenty increments higher than the strike price described in (i) of this Rule xxx.05(A) and (iii) the twenty, five point increment strike prices which are twenty increments lower than the strike price described in (i) of his Rule xxx.05(A). and
(iv) an additional ten strike prices for both call and put options will be listed at ten point increments above the highest live point increment as described in (ii) of this Rule xxx.05(A), beginning with the first available such strike that is evenly divisible by five and (v) an additional ten strike prices for both call and put options will be listed at ten point increments below the lowest five point increment as described in (iii) of this Rule xxx.05(A), beginning with the first available such strike that is evenly divisible by five.
(B) Thereafter, on any business day prior to the expiration of the option: (i) new consecutive five point increment striking prices for both puts and calls will be added such that at all times there will be at least twenty five point increment strike prices above and below the at-the-money strike price available for trading in all options contract months; and (ii) new 10 point increment strike prices will be added such that at all times there shall be ten, ten point strike prices, above and below the nearest five cent increment strike price. The at-of-the-money strike price will be determined in accordance with the procedures set forth in Subsection (B) of this Rule xxx.05.
(C) Notwithstanding the provisions of subsections (A) and (B) of this Rule, if the Board determines that trading in Texas to Louisiana Property Catastrophe futures options will be facilitated thereby, the Board may, by resolution, change the increments between strike prices, the number of strike prices which shall be traded on the first day in any new option contract month, the number of new strike prices which will be introduced on each business day or the period preceding the expiration of a Texas to Louisiana Property Catastrophe futures option in which no new strike prices may be added.
   xxx.06 Prices in Texas to Louisiana Property Catastrophe Option Contracts

Prices shall be quoted in dollars and cents per $100,000,000 of Loss as determined by ‘Re-Ex’ and prices shall be in multiples of one index point. A cabinet trade may occur at a price of 0.1 index points, or $1.00, however, if it results in the liquidation of positions for both parties to the trade.

xxx.07 Absence of Price Fluctuation Limitations for Texas to Louisiana Property Catastrophe Option Contract

Trading in Texas to Louisiana 1 Property Catastrophe option contracts shall not be subject to price fluctuation limitations.

Texas to Louisiana Property Catastrophe Binary Options Contract Example

xxx.01 Expiration of Texas to Louisiana Property Catastrophe Binary Option Contract

A Texas to Louisiana Property Catastrophe Binary Option contract on the Exchange shall expire at the close of trading on the final settlement day of the Texas to Louisiana Property Futures Contract. The expiration date shall be announced prior to the listing of the Binary Option contract.

xxx.02 Trading Unit for Texas to Louisiana Property Catastrophe Binary Option Contract

A Texas to Louisiana Property Catastrophe put Binary Option represents $ 5,000 if difference between the strike price is greater than the ‘Re-Ex’ National index or zero if the Texas to Louisiana Property Catastrophe the strike price is less than the ‘Re-Ex’ National index. A Texas to Louisiana Property Catastrophe call Binary Option represents $5,000 if difference between the strike price is less than the “Re-Ex” National index or zero if the Texas to Louisiana Property Catastrophe the strike price is greater than the ‘Re-Ex’ National index.

xxx.03 Trading Months for Texas to Louisiana Property Catastrophe Binary Option Contract

Trading in Texas to Louisiana Property Catastrophe Binary Option contracts shall be conducted in the months as shall be determined by the Board of Directors. Trading shall commence on the day fixed by resolution of the Board of Directors.

xxx.04 Hours of Trading in National Property Catastrophe Binary Option Contracts

The hours of trading in National Property Catastrophe Binary Option contracts on the Exchange shall be the same as the hours of trading for National Property Catastrophe futures contracts. All such trading shall take place on the trading floor of the Exchange within the hours prescribed by the Board.

xxx.05 Strike Prices for Texas to Louisiana Property Catastrophe Binary Option Contracts
(A) Trading shall be conducted for options with strike prices in increments as set forth below. On the first business day of trading in an option contract month, trading shall be at the following strike prices: (i) the previous day's settlement price for Texas to Louisiana Property Catastrophe futures contracts in the corresponding delivery month divided by 10 million (10,000,000) rounded off to the nearest five point increment strike price unless such settlement price is precisely midway between two Live point increment strike prices in which case it shall be rounded off to the lower five point strike price and (ii) the twenty fifty-cent increment strike prices which are twenty increments higher than the strike price described in (i) of this Rule xxx.05(A) and (iii) the twenty, five point increment strike prices which are twenty increments lower than the strike price described in (i) of this Rule xxx.05(A). and (iv) an additional ten strike prices for both call and put options will be listed at ten point increments above the highest five point increment as described in (ii) of this Rule xxx.05 (A), beginning with the first available such strike that is evenly divisible by five and (v) an additional ten strike prices for both call and put options will be listed at ten point increments below the lowest fifty-cent increment as described in (iii) of this Rule xxx.05(A), beginning with the first available such strike that is evenly divisible by five.
(B) Thereafter, on any business day prior to the expiration of the option: (i) new consecutive fifty-cent increment striking prices for both puts and calls will be added such that at all times there will be at least twenty five point increment strike prices above and below the at-the-money strike price available for trading in all options contract months; and (ii) new 10 point increment strike prices will be added such that at all times there shall be ten ten point strike prices above and below the nearest five cent increment strike price. The at-of-the-money strike price will be determined in accordance with the procedures set forth in Subsection (B) of this Rule xxx.05.
(C) Notwithstanding the provisions of subsections (A) and (B) of this Rule, if the Board determines that trading in Texas to Louisiana Property Catastrophe futures options will be facilitated thereby, the Board may, by resolution, change the increments between strike prices, the number of strike prices which shall be traded on the first day in any new option contract month, the number of new strike prices which will be introduced on each business day or the period preceding the expiration of a Texas to Louisiana 1 Property Catastrophe futures option in which no new strike prices may be added.
   xxx.06 Prices in Texas to Louisiana Property Catastrophe Binary Option Contracts

Prices shall be quoted in dollars and cents per barrel and prices shall be in multiples of 1 index point. A cabinet trade may occur at a price of 0.1 index points, or $1.00, however, if it results in the liquidation of positions for both parties to the trade.

xxx.07 Absence of Price Fluctuation Limitations for Texas to Louisiana Property Catastrophe Binary Option Contract

Trading in Texas to Louisiana Property Catastrophe Binary Option contracts shall not be subject to price fluctuation limitations.

### Virginia To Maine National Property Catastrophe Futures Contract Example

### XXX. 01 Scope

### XXX. 02 Time Reference

### XXX. 03 National Property Catastrophe Futures

### XXX. 04 Contract Value

### XXX. 05 Prices & Fluctuations

### XXX. 06 Trading Hours

### XXX. 07 Contract Months

### XXX. 08 Termination of Trading

### XXX. 09 Final Settlement

### XXX. 01 Scope

The provisions of these rules shall apply to all contracts bought or sold on the Exchange for cash settlement based on the ‘Re-EX Index.

### XXX. 02 Time Reference

For purposes of these Rules unless otherwise specified, times referred to herein shall refer to and indicate the prevailing time in New York.

### XXX. 03 Floating Price For Virginia to Maine Property Catastrophe Futures

The Floating Price for each contract month is equal to the sum of the Virginia to Maine Loss Estimates divided by $10 million for the calendar year provided by the ‘Re-Ex Index (‘Re-Ex’)

### XXX. 04 Contract Value

The contract value is the Virginia to Maine Property Catastrophe Futures multiplied by $10.

### XXX. 05 Prices & Fluctuations

Prices shall be quoted in U.S. dollars and cents per $10 million of losses. The minimum price fluctuation shall be $0.01 per $10 million in losses ($10.00 per contract). There shall be no maximum price fluctuation.

### XXX. 06 Trading Hours

The contract is available for trading on the CME Globex® trading platform from 6:00 PM Sundays through 5:15 PM Fridays, with a 45-minute break each day between 5:15 PM and 6:00 PM.

Off-Exchange transactions can be submitted solely for clearing to the NYMEX ClearPort® clearing website from 6:00 PM Sundays until 5:15 PM Fridays, with a 45 minute break between 5:15 and 6:00 PM Mondays through Thursdays.

### XXX. 07 Contracts Months

Trading shall be conducted in contracts in such months as shall be determined by the Board of Directors.

### XXX. 08 Termination of Trading

Trading in the current month shall cease on the last business day of the March month following the January through December loss year.

### XXX. 09 Final Settlement

Delivery under the contract shall be by cash settlement. Final settlement following termination of trading for a contract will be based on the Index value as determined by ‘Re-Ex’

### Virginia To Maine Property Catastrophe Options Contract Example

xxx.01 Expiration of Virginia to Maine Property Catastrophe Option Contract

A Virginia to Maine Property Catastrophe option contract on the Exchange shall expire at the close of trading on the final settlement day of the Virginia to Maine Property Futures Contract The expiration date shall be announced prior to the listing of the option contract.

xxx.02 Trading Unit for Virginia to Maine Property Catastrophe Option Contract

A Virginia to Maine Property Catastrophe put option represents the difference between the strike price less the “Re-Ex” National index multiplied by $10. A Virginia to Maine Property Catastrophe call option represents the difference between the “Re-Ex” national index less the strike price multiplied by $1,0.

xxx.03 Trading Months for Virginia to Maine Property Catastrophe Option Contract

Trading in Virginia to Maine Property Catastrophe option contracts shall be conducted in the months as shall be determined by the Board of Directors. Trading shall commence on the day fixed by resolution of the Board of Directors.

xxx.04 Hours of Trading in Virginia to Maine Property Catastrophe Option Contracts

The hours of trading in Virginia to Maine 1 Property Catastrophe option contracts on the Exchange shall be the same as the hours of trading for Virginia to Maine Property Catastrophe futures contracts. All such trading shall take place on the trading floor of the Exchange within the hours prescribed by the Board.

xxx.05 Strike Prices for Virginia to Maine Property Catastrophe Option Contracts
(A) Trading shall be conducted for options with strike prices in increments as set forth below. On the first business day of trading in an option contract month, trading shall be at the following strike prices:
(i) the previous day's settlement price for “RE-EX” Virginia to Maine Property Catastrophe futures contracts in the corresponding delivery month rounded off to the nearest five point increment strike price unless such settlement price is precisely midway between two five point increment strike prices in which case it shall be rounded off to the lower five point strike price and
(ii) the twenty, five point increment strike prices, which are twenty increments higher than the strike price described in (i) of this Rule xxx.05(A) and (iii) the twenty, five point increment strike prices which are twenty increments lower than the strike price described in (i) of this Rule xxx.05(A). and
(iv) an additional ten strike prices for both call and put options will be listed at ten point increments above the highest five point increment as described in (ii) of this Rule xxx.05 (A), beginning with the first available such strike that is evenly divisible by five and
(v) an additional ten strike prices for both call and put options will be listed at ten point increments below the lowest five point increment as described in (iii) of this Rule xxx.05(A), beginning with the first available such strike that is evenly divisible by five.
(B) Thereafter, on any business day prior to the expiration of the option, (i) new consecutive five point increment striking prices for both puts and calls will be added such that at all times there will be at least twenty five point increment strike prices above and below the at-the-money strike price available for trading in all options contract months; and (ii) new 10 point increment strike prices will be added such that at all times there shall be ten, ten point strike prices, above and below the nearest five cent increment strike price. The at-of-the-money strike price will be determined in accordance with the procedures set forth in Subsection (B) of this Rule xxx.05
(C) Notwithstanding the provisions of subsections (A) and (B) of this Rule, if the Board determines that trading in Virginia to Maine Property Catastrophe futures options will be facilitated thereby, the Board may, by resolution, change the increments between strike prices, the number of strike prices which shall be traded on the first day in any new option contract month, the number of new strike prices which will be introduced on each business day or the period preceding the expiration of a Virginia to Maine Property Catastrophe futures option in which no new strike prices may be added.
   xxx.06 Prices in Virginia to Maine Property Catastrophe Option Contracts

Prices shall be quoted in dollars and cents per $100.000.000 of Loss as determined by ‘Re-Ex’ and prices shall be in multiples of one index point. A cabinet trade may occur at a price of 0.1 index points, or $1.00, however, if it results in the liquidation of positions for both parties to the trade.

xxx.07 Absence of Price Fluctuation Limitations for Virginia to Maine Property Catastrophe Option Contract

Trading in Virginia to Maine 1 Property Catastrophe option contracts shall not be subject to price fluctuation limitations.

### Virginia To Maine Property Catastrophe Binary Options Contract Example

xxx.01 Expiration of Virginia to Maine Property Catastrophe Binary Option Contract

A Virginia to Maine Property Catastrophe Binary Option contract on the Exchange shall expire at the close of trading on the final settlement day of the Virginia to Maine Property Futures Contract. The expiration date shall be announced prior to the listing of the Binary Option contract.

xxx.02 Trading Unit for Virginia to Maine Property Catastrophe Binary Option Contract

A Virginia to Maine Property Catastrophe put Binary Option represents $5,000 if difference between the strike price is greater than the “Re-Ex” National index or zero if the Virginia to Maine Property Catastrophe the strike price is less than the ‘Re-Ex’ National index. A Virginia to Maine Property Catastrophe call Binary Option represents $5,000 if difference between the strike price is less than the ‘Re-Ex’ National index or zero if the Virginia to Maine Property Catastrophe the strike price is greater than the ‘Re-Ex’ National index.

xxx.03 Trading Months for Virginia to Maine Property Catastrophe Binary Option Contract

Trading in Virginia to Maine property Catastrophe Binary Option contracts shall be conducted in the months as shall be determined by the Board of Directors. Trading shall commence on the day fixed by resolution of the Board of Directors.

xxx.04 Hours of Trading in Virginia to Maine Property Catastrophe Binary Option Contracts

The hours of trading in Virginia to Maine Property Catastrophe Binary Option contracts on the Exchange shall be the same as the hours of trading for National Property Catastrophe futures contracts. All such trading shall take place on the trading floor of the Exchange within the hours prescribed by the Board.

xxx.05 Strike Prices for Virginia to Maine Property Catastrophe Binary Option Contracts
(A) Trading shall be conducted for options with strike prices in increments as set forth below. On the first business day of trading in an option contract month, trading shall be at the following strike prices; (i) the previous day's settlement price for Virginia to Maine Property Catastrophe futures contracts in the corresponding delivery month divided by 10 million (10,000,000) rounded off to the nearest five point increment strike price unless such settlement price is precisely midway between two five point increment strike prices in which case it shall be rounded off to the lower five point strike price and (ii) the twenty fifty-cent increment strike prices which are twenty increments higher than the strike price described in (i) of this Rule xxx.05(A) and (iii) the twenty, five point increment strike prices which are twenty increments lower than the strike price described in (i) of this Rule xxx.05(A). and (iv) an additional ten strike prices for both call and put options will be listed at ten point increments above the highest five point increment as described in (ii) of this Rule xxx.05 (A), beginning with the first available such strike that is evenly divisible by five and (v) an additional ten strike prices for both call and put options will be listed at ten point increments below the lowest fifty-cent increment as described in (iii) of this Rule xxx.05(A), beginning with the first available such strike that is evenly divisible by five.
(B) Thereafter, on any business day prior to the expiration of the option: (i) new consecutive fifty-cent increment striking prices for both puts and calls will be added such that at all times there will be at least twenty five point increment strike prices above and below the at-the-money strike price available for trading in all options contract months; and (ii) new 10 point increment strike prices will be added such that at all times there shall be ten ten point strike prices above and below the nearest five cent increment strike price. The at-of-the-money strike price will be determined in accordance with the procedures set forth in Subsection (B) of this Rule xxx.05.
(C) Notwithstanding the provisions of subsections (A) and (B) of this Rule, if the Board determines that trading in Virginia to Maine Property Catastrophe futures options will be facilitated thereby, the Board may, by resolution, change the increments between strike prices, the number of strike prices which shall be traded on the first day in any new option contract month, the number of new strike prices which will be introduced on each business day or the period preceding the expiration of a Virginia to Maine 1 Property Catastrophe futures option in which no new strike prices may be added.
   xxx.06 Prices in Virginia to Maine Property Catastrophe Binary Option Contracts

Prices shall be quoted in dollars and cents per barrel and prices shall be in multiples of 1 index point. A cabinet trade may occur at a price of 0.1 index points, or $1.00, however, if it results in the liquidation of positions for both parties to the trade.

xxx.07 Absence of Price Fluctuation Limitations for Virginia to Maine Property Catastrophe Binary Option Contract

Trading in Virginia to Maine Property Catastrophe Binary Option contracts shall not be subject to price fluctuation limitations.

### Europe Property Catastrophe Futures Contract Example

### XXX. 01 Scope

### XXX. 02 Time Reference

### XXX. 03 Europe Property Catastrophe Futures

### XXX. 04 Contract Value

### XXX. 05 Prices & Fluctuations

### XXX. 06 Trading Hours

### XXX. 07 Contract Months

### XXX. 08 Termination of Trading

### XXX. 09 Final Settlement

### XXX. 01 Scope

The provisions of these rules shall apply to all contracts bought or sold on the Exchange for cash settlement based on the ‘Re-EX Index.

### XXX. 02 Time Reference

For purposes of these Rules, unless otherwise specified, times referred to herein shall refer to and indicate the prevailing time in New York.

### XXX. 03 Floating Price For Europe Property Catastrophe Futures

The Floating Price for each contract month is equal to the sum of the Europe Loss Estimates divided by $10 million for the calendar year provided by the ‘Re-Ex Index (‘Re-Ex’)

### XXX. 04 Contract Value

The contract value is the Europe Property Catastrophe Futures multiplied by $10.

### XXX. 05 Prices & Fluctuations

Prices shall be quoted in U.S. dollars and cents per $10 million of losses. The minimum price fluctuation shall be $0.01 per $10 million in losses ($10.00 per contract). There shall be no maximum price fluctuation.

### XXX. 06 Trading Hours

The contract is available for trading on the CME Globex® trading platform from 6:00 PM Sundays through 5:15 PM Fridays, with a 45-minute break each day between 5:15 PM and 6:00 PM.

Off-Exchange transactions can be submitted solely for clearing to the NYMEX ClearPort® clearing website from 6:00 PM Sundays until 5:15 PM Fridays, with a 45 minute break between 5:15 and 6:00 PM Mondays through Thursdays.

### XXX. 07 Contracts Months

Trading shall be conducted in contracts in such months as shall be determined by the Board of Directors.

### XXX. 08 Termination of Trading

Trading in the current month shall cease on the last business day of the March month following the January through December loss year.

XXX. 09 Final Settlement Delivery under the contract shall be by cash settlement. Final settlement following termination of trading for a contract will be based on the Index value as determined by ‘Re-Ex’

### Europe Property Catastrophe Options Contract Example

xxx.01 Expiration of Europe Property Catastrophe Option Contract

A. EUROPE Property Catastrophe option contract on the Exchange shall expire at the close of trading on the final settlement day of the National Property Futures Contract The expiration date shall be announced prior to the listing of the option contract.

xxx.02 Trading Unit for National Property Catastrophe Option Contract

A Europe Property Catastrophe put option represents the difference between the strike price less the ‘Re-Ex’ National index multiplied by $10. A Europe 1 Property Catastrophe call option represents the difference between the ‘Re-Ex national index less the strike price multiplied by $1,0,

xxx.03 Trading Months for Europe Property Catastrophe Option Contract

Trading in Europe Property Catastrophe option contracts shall be conducted in the months as shall be determined by the Board of Directors. Trading shall commence on the day fixed by resolution of the Board of Directors.

xxx.04 Hours of Trading in Europe Property Catastrophe Option Contracts

The hours of trading in Europe Property Catastrophe option contracts on the Exchange shall be the same as the hours of trading for Europe Property Catastrophe futures contracts. All such trading shall take place on the trading floor of the Exchange within the hours prescribed by the Board.

xxx.05 Strike Prices for Europe Property Catastrophe Option Contracts
(A) Trading shall be conducted for options with strike prices in increments as set forth below. On the first business day of trading in an option contract month, trading shall be at the following strike prices:
(i) the previous day's settlement price for ‘RE-EX’ Europe Property Catastrophe futures contracts in the corresponding delivery month rounded off to the nearest five point increment strike price unless such settlement price is precisely midway between two five point increment strike prices in which case it shall be rounded off to the lower five point strike price and
(ii) the twenty, five point increment strike prices, which are twenty increments higher than the strike price described in (i) of this Rule xxx.05(A) and (iii) the twenty, five point increment strike prices which are twenty increments lower than the strike price described in (i) of this Rule xxx.05(A). and
(iv) an additional ten strike prices for both call and put options will be listed at ten point increments above the highest five point increment as described in (ii) of this Rule xxx.05 (A), beginning with the first available such strike that is evenly divisible by five and
(v) an additional ten strike prices for both call and put options will be listed at ten point increments below the lowest five point increment as described in (iii) of this Rule xxx.05(A), beginning with the first available such strike that is evenly divisible by five.
(B) Thereafter, on any business day prior to the expiration of the option: (i) new consecutive five point increment striking prices for both puts and calls will be added such that at all times there will be at least twenty five point increment strike prices above and below the at-the-money strike price available for trading in all options contract months; and (ii) new 10 point increment strike prices will be added such that at all times there shall be ten, ten point strike prices, above and below the nearest five cent increment strike price. The at-of-the-money strike price will be determined in accordance with the procedures set forth in Subsection (B) of this Rule xxx.05.
(C) Notwithstanding the provisions of subsections (A) and (B) of this Rule, if the Board determines that trading in Europe Property Catastrophe futures options will be facilitated thereby, the Board may, by resolution, change the increments between strike prices, the number of strike prices which shall be traded on the first day in any new option contract month, the number of new strike prices which will be introduced on each business day or the period preceding the expiration of a Europe Property Catastrophe futures option in which no new strike prices may be added.
   xxx.06 Prices in Europe Property Catastrophe Option Contracts

Prices shall be quoted in dollars and cents per $100,000,000 of Loss as determined by ‘Re-Ex’ and prices shall be in multiples of one index point. A cabinet trade may occur at a price of 0.1 index points, or $1.00, however, if it results in the liquidation of positions for both parties to the trade.

xxx.07 Absence of Price Fluctuation Limitations for Europe Property Catastrophe Option Contract

Trading in Europe Property Catastrophe option contracts shall not be subject to price fluctuation limitations.

### Europe Property Catastrophe Binary Options Contract Example

xxx.01 Expiration of Europe Property Catastrophe Binary Option Contract

A Europe Property Catastrophe Binary Option contract on the Exchange shall expire at the close of trading on the final settlement day of the Europe Property Futures Contract. The expiration date shall be announced prior to the listing of the Binary Option contract.

xxx.02 Trading Unit for Europe Property Catastrophe Binary Option Contract

A Europe Property Catastrophe put Binary Option represents $5,000 if difference between the strike price is greater than the ‘Re-Ex’ Europe index or zero if the Europe Property Catastrophe the strike price is less than the ‘Re-Ex’ Europe index. A Europe Property Catastrophe call Binary Option represents $5,000 if difference between the strike price is less than the ‘Re-Ex’ Europe 1 index or zero if the Europe 1 Property Catastrophe the strike price is greater than the ‘Re-Ex’ Europe index.

xxx.03 Trading Months for Europe Property Catastrophe Binary Option Contract

Trading in Europe Property Catastrophe Binary Option contracts shall be conducted in the months as shall be determined by the Board of Directors. Trading shall commence on the day fixed by resolution of the Board of Directors.

xxx.04 Hours of Trading in Europe Property Catastrophe Binary Option Contracts

The hours of trading in Europe Property Catastrophe Binary Option contracts on the Exchange shall be the same as the hours of trading for Europe Property Catastrophe futures contracts. All such trading shall take place on the trading floor of the Exchange within the hours prescribed by the Board.

xxx.05 Strike Prices for Europe Property Catastrophe Binary Option Contracts
(A) Trading shall be conducted for options with strike prices in increments as set forth below. On the first business day of trading in an option contract month, trading shall be at the following strike prices: (i) the previous day's settlement price for Europe Property Catastrophe futures contracts in the corresponding delivery month divided by 10 million (10,000,000) rounded off to the nearest five point increment strike price unless such settlement price is precisely midway between two five point increment strike prices in which case it shall be rounded off to the lower five point strike price and (ii) the twenty fifty-cent increment strike prices which are twenty increments higher than the strike price described in (i) of this Rule xxx.05(A) and (iii) the twenty, five point increment strike prices which are twenty increments lower than the strike price described in (i) of this Rule xxx.05(A). and (iv) an additional ten strike prices for both call and put options will be listed at ten point increments above the highest five point increment as described in (ii) of this Rule xxx.05 (A), beginning with the first available such strike that is evenly divisible by five and (v) an additional ten strike prices for both call and put options will be listed at ten point increments below the lowest fifty-cent increment as described in (iii) of this Rule xxx.05(A), beginning with the first available such strike that is evenly divisible by five.
(B) Thereafter, on any business day prior to the expiration of the option: (i) new consecutive fifty-cent increment striking prices for both puts and calls will be added such that at all times there will be at least twenty five point increment strike prices above and below the at-the-money strike price available for trading in all options contract months; and (ii) new 10 point increment strike prices will be added such that at all times there shall be ten ten point strike prices above and below the nearest five cent increment strike price. The at-of-the-money strike price will be determined in accordance with the procedures set forth in Subsection (B) of this Rule xxx.05.
(C) Notwithstanding the provisions of subsections (A) and (B) of this Rule, if the Board determines that trading in Europe Property Catastrophe futures options will be facilitated thereby, the Board may, by resolution, change the increments between strike prices, the number of strike prices which shall be traded on the first day in any new option contract month, the number of new strike prices which will be introduced on each business day or the period preceding the expiration of a Europe Property Catastrophe futures option in which no new strike prices may be added.
   xxx.06 Prices in Europe Property Catastrophe Binary Option Contracts

Prices shall be quoted in dollars and cents per barrel and prices shall be in multiples of 1 index point. A cabinet trade may occur at a price of 0.1 index points, or $1.00, however, if it results in the liquidation of positions for both parties to the trade.

xxx.07 Absence of Price Fluctuation Limitations for Europe Property Catastrophe Binary Option Contract

Trading in Europe Property Catastrophe Binary Option contracts shall not be subject to price fluctuation limitations.

### Japan Property Catastrophe Futures Contract Example

### XXX. 01 Scope

### XXX. 02 Time Reference

### XXX. 03 Japan Property Catastrophe Futures

### XXX. 04 Contract Value

### XXX. 05 Prices & Fluctuations

### XXX. 06 Trading Hours

### XXX. 07 Contract Months

### XXX. 08 Termination of Trading

### XXX. 09 Final Settlement

### XXX. 01 Scope

The provisions of these rules shall apply to all contracts bought or sold on the Exchange for cash settlement based on the ‘Re-EX Index.

### XXX. 02 Time Reference

For purposes of these Rules, unless otherwise specified, times referred to herein shall refer to and indicate the prevailing time in New York.

XXX. 03 Floating Price For Japan Property Catastrophe Futures

The Floating Price for each contract month is equal to the sum of the Japan Loss Estimates divided by $10 million for the calendar year provided by the ‘Re-Ex Index (‘Re-Ex’)

### XXX. 04 Contract Value

The contract value is the Japan 1 Property Catastrophe Futures multiplied by $10.

### XXX. 05 Prices & Fluctuations

Prices shall be quoted in U.S. dollars and cents per $10 million of losses. The minimum price fluctuation shall be $0.01 per $10 million in losses ($10.00 per contract). There shall be no maximum price fluctuation.

### XXX. 06 Trading Hours

### The contract is available for trading on the CME Globex® trading platform from 6:00 PM Sundays through 5:15 PM Fridays, with a 45-minute break each day between 5:15 PM and 6:00 PM.

Off-Exchange transactions can be submitted solely for clearing to the NYMEX ClearPort® clearing website from 6:00 PM Sundays until 5:15 PM Fridays, with a 45 minute break between 5:15 and 6:00 PM Mondays through Thursdays.

### XXX. 07 Contracts Months

Trading shall be conducted in contracts in such months as shall be determined by the Board of Directors.

### XXX. 08 Termination of Trading

Trading in the current month shall cease on the last business day of the March month following the January through December loss year.

### XXX. 09 Final Settlement

Delivery under the contract shall be by cash settlement. Final settlement following termination of trading for a contract will be based on the Index value as determined by ‘Re-Ex’

### Japan Property Catastrophe Options Contract Example

xxx.01 Expiration of Japan 1 Property Catastrophe Option Contract

A Japan Property Catastrophe option contract on the Exchange shall expire at the close of trading on the final settlement day of the National Property Futures Contract The expiration date shall be announced prior to the listing of the option contract.

xxx.02 Trading Unit for Japan Property Catastrophe Option Contract

A Japan Property Catastrophe put option represents the difference between the strike price less the ‘Re-Ex’ National index multiplied by $10. A Japan 1 Property Catastrophe call option represents the difference between the ‘Re-Ex’ national index less the strike price multiplied by $1,0.

xxx.03 Trading Months for Japan Property Catastrophe Option Contract

Trading in Japan Property Catastrophe option contracts shall be conducted in the months as shall be determined by the Board of Directors. Trading shall commence on the day fixed by resolution of the Board of Directors.

xxx.04 Hours of Trading in Japan Property Catastrophe Option Contracts

The hours of trading in Japan Property Catastrophe option contracts on the Exchange shall be the same as the hours of trading for Japan Property Catastrophe futures contracts. All such trading shall take place on the trading floor of the Exchange within the hours prescribed by the Board.

xxx.05 Strike Prices for Japan Property Catastrophe Option Contracts
(A) Trading shall be conducted for options with strike prices in increments as set forth below. On the first business day of trading in an option contract month, trading shall be at the following strike prices:
(i) the previous day's settlement price for ‘RE-EX’ Japan Property Catastrophe futures contracts in the corresponding delivery month rounded off to the nearest five point increment strike price unless such settlement price is precisely midway between two five point increment strike prices in which case it shall be rounded off to the lower five point strike price and
(ii) the twenty, five point increment strike prices, which are twenty increments higher than the strike price described in (i) of this Rule xxx.05(A) and (iii) the twenty, five point increment strike prices which are twenty increments lower than the strike price described in (i) of this Rule xxx.05(A). and
(iv) an additional ten strike prices for both call and put options will be listed at ten point increments above the highest five point increment as described in (ii) of this Rule xxx.05 (A), beginning with the first available such strike that is evenly divisible by five and
(v) an additional ten strike prices for both call and put options will be listed at ten point increments below the lowest five point increment as described in (iii) of this Rule xxx.05(A), beginning with the first available such strike that is evenly divisible by five.
(B) Thereafter, on any business day prior to the expiration of the option: (i) new consecutive five point increment striking prices for both puts and calls will be added such that at all times there will be at least twenty five point increment strike prices above and below the at-the-money strike price available for trading in all options contract months; and (ii) new 10 point increment strike prices will be added such that at all times there shall be ten, ten point strike prices, above and below the nearest five cent increment strike price. The at-of-the-money strike price will be determined in accordance with the procedures set forth in Subsection (B) of this Rule xxx.05.
(C) Notwithstanding the provisions of subsections (A) and (B) of this Rule, if the Board determines that trading in Japan Property Catastrophe futures options will be facilitated thereby, the Board may, by resolution, change the increments between strike prices, the number of strike prices which shall be traded on the first day in any new option contract month, the number of new strike prices which will be introduced on each business day or the period preceding the expiration of a Property Catastrophe futures option in which no new strike prices may be added.
   xxx.06 Prices in Japan Property Catastrophe Option Contracts

Prices shall be quoted in dollars and cents per $100,000,000 of Loss as determined by ‘Re-Ex’ and prices shall be in multiples of one index point. A cabinet trade may occur at a price of 0.1 index points, or $1.00, however, if it results in the liquidation of positions for both parties to the trade.

xxx.07 Absence of Price Fluctuation Limitations for National Property Catastrophe Option Contract

Trading in Japan Property Catastrophe option contracts shall not be subject to price fluctuation limitations.

### Japan Property Catastrophe Binary Options Contract Example

xxx.01 Expiration of Japan Property Catastrophe Binary Option Contract

A Japan Property Catastrophe Binary Option contract on the Exchange shall expire at the close of trading on the final settlement day of the Japan Property Futures Contract. The expiration date shall be announced prior to the listing of the Binary Option contract.

xxx.02 Trading Unit for Japan Property Catastrophe Binary Option Contract

A Japan Property Catastrophe put Binary Option represents $5,000 if difference between the strike price is greater than the ‘Re-Ex’ Japan index or zero if the Japan Property Catastrophe the strike price is less than the ‘Re-Ex’ National index. A Japan e Property Catastrophe call Binary Option represents $5,000 if difference between the strike price is less than the ‘Re-Ex’ Japan 1 index or zero if the Japan 1 Property Catastrophe the strike price is greater than the ‘Re-Ex’ National index.

xxx.03 Trading Months for Japan Property Catastrophe Binary Option Contract Trading in Japan Property Catastrophe Binary Option contracts shall be conducted in the months as shall be determined by the Board of Directors. Trading shall commence on the day fixed by resolution of the Board of Directors.
xxx.04 Hours of Trading in Japan Property Catastrophe Binary Option Contracts

The hours of trading in Japan Property Catastrophe Binary Option contracts on the Exchange shall be the same as the hours of trading for Japan Property Catastrophe futures contracts. All such trading shall take place on the trading floor of the Exchange within the hours prescribed by the Board.

xxx.05 Strike Prices for Japan Property Catastrophe Binary Option Contracts
(A) Trading shall be conducted for options with strike prices in increments as set forth below. On the first business day of trading in an option contract month, trading shall be at the following strike prices: (i) the previous day's settlement price for Japan Property Catastrophe futures contracts in the corresponding delivery month divided by 10 million (10,000,000) rounded off to the nearest five point increment strike price unless such settlement price is precisely midway between two five point increment strike prices in which case it shall be rounded off to the lower five point strike price and (ii) the twenty fifty-cent increment strike prices which are twenty increments higher than the strike price described in (i) of this Rule xxx.05(A) and (iii) the twenty, five point increment strike prices which are twenty increments lower than the strike price described in (i) of this Rule xxx.05(A). and (iv) an additional ten strike prices for both call and put options will be listed at ten point increments above the highest five point increment as described in (ii) of this Rule xxx.05 (A), beginning with the first available such strike that is evenly divisible by five and (v) an additional ten strike prices for both call and put options will be listed at ten point increments below the lowest fifty-cent increment as described in (iii) of this Rule xxx.05(A), beginning with the first available such strike that is evenly divisible by five.
(B) Thereafter on any business day prior to the expiration of the option: (i) new consecutive fifty-cent increment striking prices for both puts and calls will be added such that at all times there will be at least twenty five point increment strike prices above and below the at-the-money strike price available for trading in all options contract months; and (ii) new 10 point increment strike prices will be added such that at all times there shall be ten ten point strike prices above and below the nearest five cent increment strike price. The at-of-the-money strike price will be determined in accordance with the procedures set forth in Subsection (B) of this Rule xxx.05.
(C) Notwithstanding the provisions of subsections (A) and (B) of this Rule, if the Board determines that trading in Japan 1 Property Catastrophe futures options will be facilitated thereby the Board may, by resolution, change the increments between strike prices, the number of strike prices which shall be traded on the first day in any new option contract month, the number of new strike prices which will be introduced on each business day or the period preceding the expiration of a National Property Catastrophe futures option in which no new strike prices may be added.
   xxx.06 Prices in Japan 1 Property Catastrophe Binary Option Contracts

Prices shall be quoted in dollars and cents per barrel and prices shall be in multiples of 1 index point. A cabinet trade may occur at a price of 0.1 index points, or $1.00, however, if it results in the liquidation of positions for both parties to the trade.

xxx.07 Absence of Price Fluctuation Limitations for Japan Property Catastrophe Binary Option Contract

Trading in Japan e Property Catastrophe Binary Option contracts shall not be subject to price fluctuation limitations.

It is claimed:

1. A method for trading reinsurance risk on a futures-based or options exchange, said method comprising:
receiving information related to one or more futures-based or options reinsurance catastrophe contracts;
generating a transaction with respect to the one or more futures-based or options reinsurance catastrophe contracts based upon the information received about the one or more futures-based or options reinsurance catastrophe contract;
using the futures-based exchange as a clearing house with respect to the generated transaction;
wherein a futures based annual index of all losses above a pre-specified amount as reported by Property claims Services (PCS) in a given period is used as an index for the exchange.

2. The method of claim 1, wherein the step of using the futures-based exchange as a clearing house includes using the futures-based exchange to provide financial clearing services with respect to the generated transaction.

3. The method of claim 2, wherein the step of using the futures-based exchange as a clearing house includes using the futures-based exchange to provide financial settlement services with respect to the generated transaction.

4. The method of claim 1, wherein the step of using the futures-based exchange as a clearing house includes using the futures-based exchange to provide financial settlement services with respect to the generated transaction.

5. The method of claim 1, wherein the futures-based exchange acts as a central counterparty with respect to the generated transaction.

6. The method of claim 1, wherein the generating of the transaction includes buying the one or more futures-based reinsurance catastrophe contracts.

7. The method of claim 1, wherein the generating of the transaction includes selling the one or more futures-based reinsurance catastrophe contracts.

8. The method of claim 1, wherein the trading of the futures-based reinsurance catastrophe contracts provides positive funding to buyers before the buyers actually pay their clients' claims or in advance of pre-specified regulatory funding requirements.

9. The method of claim 1, wherein the futures-based or options contract does not include having to prove loss to a reinsurer or retrocessionaire who is to settle a claim.

10. The method of claim 1, wherein the one or more futures-based reinsurance catastrophe contract includes one or more over-the-counter (OTC) reinsurance catastrophe contracts.

11. The method of claim 1, wherein the futures-based exchange has regulations that establish standardized contract terms for reinsurance catastrophe futures-based contracts, wherein the one or more futures-based reinsurance catastrophe contract contain the standardized contract terms.

12. The method of claim 1, wherein the one or more futures-based reinsurance catastrophe contracts are based upon a pre-specified format.

13. The method of claim 1, wherein the format is an ISDA based standard contract.

14. The method of claim 1 wherein the standardized contract terms for the one or more futures-based reinsurance catastrophe contracts include one or more standardized terms which specify that loss figure is a figure provided by a pre-specified organization.

15. The method of claim 14, wherein the pre-specified organization is PCS.

16. The method of claim 14, wherein the trading of the one or more futures-based reinsurance catastrophe contracts begins in January of a pre-specified year.

17. The method of claim 1, wherein the step of receiving the information includes receiving the information over one or more computer networks.

18. The method of claim 17, wherein the one or more computer networks include local area networks (LANs), wide area networks (WANs), wireless networks, internet networks, intranet networks, and combinations thereof.

19. The method of claim 17, further comprising:
displaying upon a screen of a trader's computer the received information that is related to the one or more futures-based reinsurance catastrophe contracts;
using the trader's computer for generating the transaction;
communicating with the futures-based exchange over the one or more computer networks regarding the generated transaction.

20. The method of claim 19, wherein the use of the one or more computer networks to receive the information and to communicate with the futures-based exchange regarding the generated transaction allows trading of the one or more futures-based reinsurance catastrophe contracts to occur in real-time or near real-time.

21. The method of claim 1, wherein the transaction is with respect to a standardized atmospheric or seismic property damage futures and options that is based upon the index.

22. A computer-implemented system for trading reinsurance risk on a futures-based or options exchange, comprising:
a server configured to receive information related to one or more futures-based or options reinsurance catastrophe contracts;
a database to store the received information related to the one or more future-based or options reinsurance catastrophe contracts;
wherein the server generates a transaction with respect to the one or more futures-based or options reinsurance catastrophe contracts based upon the information received about the one or more futures-based or options reinsurance catastrophe contract;
wherein the server is a futures-based exchange server and operates as a clearing house with respect to the generated transaction;
wherein a futures based annual index of all losses above a pre-specified amount as reported by Property claims Services (PCS) in a given period is used as an index for the exchange.
